(19) United States
(12) Patent Application Publication
(10) Pub. No.: US 2021/0174360 A1
(43) Pub. Date: Jun. 10, 2021

(54) BLOCKCHAIN SYSTEM

(71) Applicant: Velo Holdings Limited, London (GB)

(72) Inventors: John Terrell DAVIES, London (GB); Andrew WEINSTEIN, Ross, CA (US); Justin HANDVILLE, London (GB)

(21) Appl. No.: 16/761,633

(22) PCT Filed: Nov. 6, 2018
(86) PCT No.: PCT/US2018/059474

§ 371 Date: May 5, 2020

Related U.S. Application Data
(60) Provisional application No. 62/582,073, filed on Nov. 6, 2017.

(51) Int. Cl. G06Q 20/38; G06Q 20/10; H04L 9/06

(52) U.S. Cl. CPC G06Q 20/3827; G06Q 20/102; H04L 2209/56; H04L 9/0618; H04L 2209/38; H04L 9/0643

(57) ABSTRACT

A blockchain is identified by a plurality of certificates of different types. The certificate format is optimized to be compact and easily described. Parsing the certificate is secure. The certificate is extendible through a self-describing mechanism.

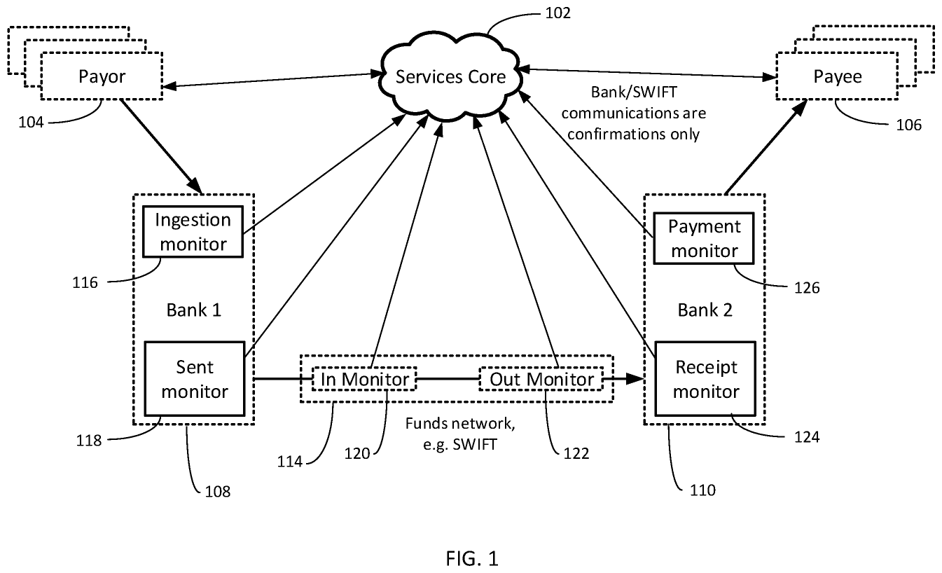

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Blockchain technology may be applied to many transaction types. In some cases, such as an anonymous digital currency, a work function is added to slow down transactions to prevent double spending. However, transactions between known and auditable entities may be less concerned about double spending and have a greater interest on scalability.

### SUMMARY

A blockchain system uses a tagged binary data format to build a blockchain certificate that is compact, easily described, secure, and which may be extendable through a self-describing mechanism.

### BRIEF DESCRIPTION OF THE FIGURE

The FIGURES depict a preferred embodiment for purposes of illustration only. One skilled in the art may readily recognize from the following discussion that alternative embodiments of the structures and methods illustrated herein may be employed without departing from the principles described herein.

The FIGURE is a block diagram of a system implementing encrypted and authenticated message services;

### DETAILED DESCRIPTION

The FIGURE illustrates an embodiment of elements supporting an encrypted and authenticated message service that addresses the drawbacks of the SWIFT network while reducing the overall number of transactions requiring international funds transfers. A services core 102 may incorporate access to payor accounts and obligations while also providing payees a way to self-maintain accounts and set preferences for payouts. The services core 102 may also match obligations and receivables, including a predictive service for anticipating future needs, that allows net settlement of accounts in-country before initiating international transfers of funds with a home country and currency. The net settlement may occur (i) inside the services core 102 itself, (ii) between the services core 102 and corporate client's ERP and other treasury management systems' services cores, or (iii) amongst the services core 102, and multiple corporate clients' systems, which would allow the primary services core 102 to act as an exchange between two corporate actors' service cores.

The services core 102 may be coupled to both a payor 104 and a payee 106, each of which may represent a plurality of payors and payees. A first bank 108 and a second bank 110 represent any number of financial institutions that may routinely participate in funds transfers between the payor 104 and the payee 106. A communications network 114 may support messages containing instructions for financial transfers, or may use a proprietary communication protocol, or merely proprietary security protocol (e.g., keys) on a non-proprietary communication network. In an embodiment, the communications network 114 may be the SWIFT network or any other standards-based payment or messaging network, but in other embodiments, the communications network 114 may be any public or private entity that acts in this capacity.

The FIGURE also illustrates a sample flow of instructions related to a payment or other funds transfer. The flow follows from the payor 104, to the first bank 108, through the communications network 114, to the second bank 10, and ultimately to the payee 106. Funds flow and messaging is omni-directional. Actual funds may be transferred between adjacent entities except that the communications network 114 generally does not hold any accounts or perform any payment or settlement.

An aspect of the ability of the services core 102 to perform its various roles is collection of data at various points in the transfer process through the use of sensors or monitors. The rust bank 108 may have monitors where data is received and where data exits [NOTE: see comments above, we will put sensors everywhere, so in our engine]. These may be, respectively, an ingestion monitor 116 and a sent monitor 118. Similarly, the communication network 114 may have an in monitor 120 and an out monitor 122. Finally, the second bank 110 may have a receipt monitor 124 and a payment monitor 126. These monitors, and those discussed below are merely representative of monitors which may be placed at every transfer and activity point in all participating system elements. For example, every step in the process may include monitoring, which extends to all systems that interoperate with the services core 102. These monitors may provide, constant, rich data based on business rules that are configurable for workflow changes per the needs of each client. In each instantiation, the monitoring may change with the workflow. For example, all RESTful APIs at each communication point may include monitoring.

Each network or communication function may include monitors as needed, including private networks, virtual private networks. In the case of the SWIFT network, the in and out monitors 120, 122 may be present in a current release of that system and require no development on the part of the SWIFT network although the bank 108 may be required to request the data provided by the in and out monitors 120, 122, via a programmatic interface. In the following description, certain monitors and their associated functions are disclosed. These monitors are shown for the purpose of illustration and in different embodiments there may be more or fewer monitors in each of the entities in the transaction flow, each providing a window into the state of the transaction at the point of the monitor. In an embodiment, each processing function in the transaction flow may include a monitor or sensor that reports back to the services core 102 as much data as may be relevant. This may include completion of the function but may also include other data such as initiation or intermediate processing steps. RESTful API's may expose as much or a little data as determined by system architects or designers. Some or all of this data may then be reported to the payor 104 and the payee 106, as desired or appropriate.

Banks and other financial institutions are highly regulated and changes to data flow and routine processes may be difficult to implement. For that reason, various monitors may sit above the actual financial processing flow. For example, while a payment message received at the first bank 108 may arrive tom the payor 104 via a known channel such as a secure extranet or virtual private network (VPN), the monitors 116-126 may not use or have access to these secure channels. APIs are available for all functions that include monitoring, and therefore even if a monitor cannot be included inside the function, the services core 102 can monitor the errors created during a function, or successful processing of such function, such that the next function begins.

Of note is that, in an embodiment, each of the monitors illustrated only reports out confirmation data to the services core 102 and the content of messages are status only. Transactions may be referred to, in some cases, only by a transaction identifier so that minimal information is delivered, reducing the ability for an unwanted actor to glean information even if a status message is compromised. Because the monitoring messages are status only and outbound only, the banks 108, 110 may not need to take extraordinary data security precautions that might arise if inbound messages were being processed. For example, bank firewalls (not depicted) may only allow outbound traffic (other than low-level confirmation protocol-related incoming data). However, such a minimal amount of data may also have a minimal amount of error checking data and errors, which commonly would be caught may flow through a system. For example, if a payee name AND account number were included in a message, the account number may be promptly checked against the payee name and a mis-match may be caught virtually immediately.

The status or confirmation messages may be formatted in compliance with an agreed upon application program interface (API) that facilitates easy setup, debugging, and operation. Funds transfers between banks 108, 110 may be symmetric and have equivalent monitors in either direction, however, for the sake of simplicity for this disclosure, only one direction of flow and those associated monitors are shown.

The elements depicted may be intended to function with no to minimal changes to the current flow of a transfer used in a prior deployment. That is, a payor 104 may have an enterprise resource planning function, treasury management software or similar application that determines what obligations are due each recipient or payee. That information may be forwarded to an operation of the payor's treasury department where a flat file of payment information is assembled. The flat file, or simple ASCII text, may have one row per payment, with each row designating a payee, any required regulatory explanations, a source account, a destination account, and an amount, with variations by payor company, bank, and method. The flat file may be sent to the payor's bank 108. The bank 108 may process the flat file and, when required, may generate SWIFT messages with similar information as above. Next, the SWIFT message may be received by the recipient bank t 10. The recipient bank 110, presumably holding an account for the payee 106, may make a deposit to the recipient account, and ultimately settlement with the payor's bank 108 may be made. In an embodiment, the payment instruction from payor 104 will go to the services core 102 and be ingested, resulting in instructions occurring in this exemplary order: 1) confirm payee preferences in services core 102; 2) Net settle across portfolios to have disbursement funds in each local market; 3) Where net settlement lacks sufficient funds, use currency exchange or float to deliver local funds, replacing multiple SWIFT transactions with a bulk funds transfer; 4) Once in-country, deliver funds to bank accounts, e-wallets, cards, cash. 5) Generate real-time alerts for key steps for payor 104 (e.g., into SAP) & payees 106 throughout workflow. In this embodiment, steps 3 and 4 may use traditional bank messaging.

In such an environment, once the first flat file is delivered to the bank 108, today there may be no further confirmation messages fed back to the payor 104 or the bank 108 until an actual settlement is completed. If any upstream participant wants to confirm receipt by a downstream participant, or if settlement fails to occur in an expected timeframe, the upstream participant generally makes a phone call to the other party to get a verbal confirmation. When such confirmation involved in tracking and correcting lost transactions is in a range of 1-2 percent of dozens or even hundreds of payments, the associated overhead may be an acceptable cost of business. However, this manual process of verification, tracking and correction does not scale well. When millions of payments of both large and small value transfers are being made, the cost of manual follow up on a 1-2 percent error rate may become unacceptable high. The monitors contribute to scaling to higher volumes and help diagnose a point in the transaction routing where an error occurred or at least was first identified.

The ingestion monitor 116 may support unidirectional messaging with the services core 102, with the understanding that any communication protocol requires at least some level of two-way signaling associated with sending even a unidirectional message. The ingestion monitor 116, like the other monitors, may be in the form of an application program interface (API) using, for example, a RESTful interface, that collects data from a specific point in the transfer sequence. The bank 108 may simply use the API to extract the needed data and forward it to the services core 102. The ingestion monitor 116 may collect data from an incoming data buffer or database in one embodiment.

In another embodiment, the data may be collected after the flat file has been processed by the bank 108 prior to forwarding to the next entity. In one embodiment, only a transaction ID may be sent, minimizing personally identifiable data from being transmitted. However, in another embodiment, the API may be used to extract all possible details related to the transaction so that more detailed error detection may be performed at services core 102. The RESTful API allows for payor 104 to send the services core 102 payment instructions dynamically, and the services core 102 will disaggregate each element of the payment instruction in order to respond to each element of payee instructions, and pass funds flow through lowest cost routing.

When an error is detected, a message may be generated and sent to the bank 108, indicating the error. The bank 108 may be motivated to provide monitor data as a way of reducing its own cost of doing business as relates to identification of errors, even those errors that occur outside the bank 108 but for which the bank 108 must expend resources to eliminate itself as the source. Because the bank 108 is only providing data, its compliance obligations related to data security may be minimized compared to receipt of external files from a third party.

As implied by the name, the sent monitor 108 may transmit a confirmation when the transaction data leaves the bank 108 and is sent to the communications network 114. As above, the communication may be minimal or may expansive. When the communications network 114 is the SWIFT network, existing monitors 120, 122 may be used to confirm entry and exit of data from the network 114. In other communications networks, the monitors 120, 122 may also be implemented using the same or a similar API as used in the bank, performing essentially the same functions of reporting status, with or without complete transaction details.

Similarly, the second bank 110 or an additional receive provider like PayPal or Alipay, or cash out service provider like Western Union, or multiple trading desks globally across a single bank may have monitors placed at points within the its internal transaction process. The receipt monitor 124 may confirm transaction details as received or as processed after receipt, or both. The payment monitor 126 may report the completion of the payment to the end payee 106.

### Overview

This document details the low-level data layout of certificates. It also outlines the basic process of creating a blockchain and block canonization. This document concludes with a worked example demonstrating a simplified universe for the disbursement of payments between a single payer and a single payee.

Note that this is a document describing a work in progress. Some details may change in the final implementation, and many things will only be described in terms of how they are currently understood. We will avoid describing in detail things that are most likely to change in the future as well as things that are understood generally but currently lack a complete design or implementation.

The purpose of this document, primarily, is to familiarize Velo technical staff with some of the details regarding the Velo blockchain, which will assist in the development of this technology and also to help explain this technology to others.

### Data Layout

The next section in this document sketches the data layout for the Velo blockchain, first by describing the layout of Velo certificates, and then by describing transactions. The transaction is the basic building block of the Velo blockchain. Artifacts and Entities, which are the logical “things” described by the Velo blockchain, have no firm substance. When we describe these things, we do so by describing transactions that change the state of these things.

### Worked Example

The final section in this document describes a worked example of a simplified blockchain universe with a single payer and a single payee. This example glosses over some of the contract details, but provides the data layout for an example root block, and a couple of blocks with transactions kicking forward a simple disbursement.

### Basic Concepts

Before describing the Velo Certificate layout, and the various Velo certificates, we should describe some basic concepts.

The Velo Blockchain describes Artifacts through Transactions which change the state of Artifacts. An Artifact is a “thing” described by a Transaction. An Artifact has a type, known as an Artifact Type, which is itself a type of Artifact. To prevent infinite regression, there is a penultimate type, known as the Artifact Type Type, which is the type of all Artifact Types.

Artifacts are described through Transactions. Each Artifact has an initial state and a final, or Destroyed state. A Transaction changes the state of the Artifact and decorates the Artifact with fields. Each Artifact has a defined state chart that ultimately concludes with the Artifact's destruction.

Entities are a special type of Artifact, which can the ability to perform Transactions on other Artifacts. The initial Entity is the system is the Root Entity. The Root Entity resides in the Root Block, which is the very first Block in the blockchain. The Root Entity first creates itself, and then creates the “universe” of the blockchain. It defines the Artifact Type Type, as well as any special Artifact Types and Entities required to run the initial blockchain. Each of these are created as transactions within the Root Block. The final transaction that the root entity performs is the transaction which destroys itself. The Root Entity does not survive past the signing of the Root Block.

Block Agents are special Entities in the system which have the ability to vote on new Blocks, which are appended to the blockchain. A Block is a special type of certificate describing a Block level transaction, which canonizes the Transactions contained within it to the blockchain. Thus, a Block is both a link in the blockchain and a container of Transactions.

Every Transaction in the system must be signed by an Entity authorized to perform the Transaction. Authorization is managed through two complementary systems. Grant Descriptors and Grants provide a way by which the basic structure of authorization can be described. The former is a relation of which Artifact Types and Entity Types are allowed to collaborate on a given Transaction Type. The latter is an explicit grant for a given Entity or set of Entities to perform a given transaction on a given Artifact or set of Artifacts. The second system, complementing the Grant/Grant Descriptor system is the Contract. A Contract is an executable bit of bytecode which performs additional checks on a Transaction to ensure that it is valid. It adds intelligence to the Grant system. Contracts are not described in detail in this document.

### Velo Certificates

The Velo Certificate is a simple tagged binary data format that meets three requirements necessary for an extensible blockchain:

1. The format is compact.
2. The format can be easily described and parsing is trivially secure.
3. The format can be extended through a self-describing mechanism.

There are many formats that purport to meet one or more of these requirements. XML, for instance, is highly extensible. However, it is neither compact—in fact it is quite verbose—nor can the format be easily described. Furthermore, a compliant implementation of XML suffers from one or more potential security flaws that are built right into the specification. JSON is a better choice. It is possible to write a secure parser for JSON through composition. The format can be extended. It lacks a formal self-describing mechanism for new fields, but the format is so simple that one of many potential solutions can be used. However, JSON is not compact. As a final example, consider Google Protocol Buffers. This format likely comes die closest to matching each of these three requirements. It is relatively compact. While Protocol Buffers can't be described as simply as we would like, it can be formally described and it is possible to build a relatively secure parser for it. The format can be extended, and it does support a sort of schema that satisfies the self-describing mechanism. In some ways, Google Protocol Buffers is superior to what we will describe, especially in the way in which it handles variable-length data. However, there is a significantly higher overhead for parsing Protocol Buffers, and the complexity versus feature trade-off is higher than we would like. Other formats, such as BSON, YAML, etc., can be described and, but we think that the three examples are fairly representative of the sorts of formats typically encountered in contemporary open standards.

### Field Layout

The Velo Certificate format is a simple tagged binary data format. It is similar to Microsoft's BIFF (Binary Interchange File Format), used in Excel for many years, except that it is more rigidly defined and has support for extended field type mapping. A Velo Certificate is made of one or more fields. Each field has a Field Type and Field Length, as well as a data value which can range in size from zero to 2¹⁶−1 or 65,535 bytes in length. The following table describes the basic layout of a field in a Velo Certificate.

| Field | Description |
|---|---|
| Field Type | Unsigned 16-bit integer. Encoded as Big-Endian. |
| Field Length | Unsigned 16-bit integer. Encoded as Big-Endian. |
| Field Data | Variable length data field, equal to Field Length. |

It is possible to embed certificate fragments as the field data. For instance, tuples and other complex data structures can be described this way. However, the largest field size is 2¹⁶−1, which means that embedded certificate fragments cannot exceed this length. A Velo Certificate prefers “shallow embedding” (not to be confused with the formal definition in mathematics!) in practice, meaning that it is better to have a flat data layout with semantically meaningful divisions. That being said, embedded certificate fragments and embedded certificates are common. For instance, the Block Transaction embeds Transaction certificates in it, meaning that Transaction certificates must be 64 kilobytes in size or smaller. This ensures that Blocks are relatively small by forcing this constraint on Transactions, and also ensures that designs using Transactions will prefer many small transactions over few monolithic transactions.

### Field Types

The Velo Certificate Format reserves some field types as built-in values at the bottom of the field type range and some field types for extension at the top of the field type range. The rest of the field types are available for user-defined fields, which are specific for a given transaction type. The following table describes the field types currently defined in the system. Note that this is not a comprehensive list, as more field types will be defined in the release of the Velo Blockchain.

| Field Type | Description |
|---|---|
| 0x0000 | Reserved Zero-Tag. |
| 0x0001 | Certificate Format Version. Unsigned 32-bit Big-Endian. Should be set to |
| | 0x00010000 for this format. The minor version is incremented for |
| | non-breaking changes. |
| 0x0010 | Valid-from. Signed 64-bit Big-Endian. Seconds since Unix Epoch. Can |
| | be negative to denote time before Epoch. |
| 0x0011 | Valid-until. Signed 64-bit Big-Endian. Seconds since Unix Epoch. Can |
| | be negative to denote time before Epoch. |
| 0x0020 | Crypto Suite. Unsigned 16-bit Big-Endian. 0x0001 denotes Velo |
| | Curve25519/Ed25519/SHA-512. |
| 0x0030 | Certificate Type. 128-bit UUID. Typically the Transaction type for Velo |
| | Blockchain related certificates. |
| 0x0038 | Certificate ID. 128-bit UUID. A unique identifier for this certificate. |
| | Typically referred to as the Transaction ID for transaction certificates. |
| 0x0039 | Previous Certificate ID. 128-bit UUID. A link to the previous certificate |
| | identifier when creating certificate chains. In the case of a transaction |
| | certificate, the previous transaction for this artifact. |
| 0x003A | Next Certificate ID. 128-bit UUID. A link to the next certificate identifier |
| | when creating forward chains. Used for multi-part certificates. |
| 0x0040 | Artifact Type. 128-bit UUID. Used to describe the type of artifact being |
| | created in an artifact creation transaction, or the artifact type being |
| | referenced in artifact type related transactions. |
| 0x0041 | Artifact ID. 128-bit UUID. Used to reference an artifact in a transaction. |
| 0x0042 | Previous Artifact State. Unsigned 16-bit Big Endian. The previous state of |
| | this artifact. |
| 0x0043 | New Artifact State. Unsigned 16-bit Big Endian. The state to which this |
| | artifact is transitioning in a transaction. |
| 0x0050 | Signer ID. 128-bit UUID. The entity signing a certificate. Must be the |
| | second-to-last field in a certificate. |
| 0x0051 | Signature. The digital signature of this certificate. The format of this field |
| | depends on the crypto suite. For crypto suite 0x0001, this is an Ed25519 |
| | signature, which is a 512-bit value. This must be the last field in a |
| | certificate. |
| 0x0052 | Public Encryption Key. The public portion of the encryption key for the |
| | entity described in this certificate. The format of this field depends on the |
| | crypto suite. |
| 0x0053 | Public Signing Key. The public portion of the signing key for the entity |
| | described in this certificate. The format of this field depends on the crypto |
| | suite. |
| 0x0054 | Private Encryption Key. The private portion of the encryption key for an |
| | entity private certificate. Note that this field will never appear in the |
| | blockchain, but will appear in a private entity certificate. The format of the |
| | private entity certificate is not in scope for this document. |
| 0x0055 | Private Signing Key. The private portion of the signing key for an entity |
| | private certificate. Note that this field will never appear in the blockchain, |
| | but will appear in a private entity certificate. The format of the private |
| | entity certificate is not in scope for this document. |
| 0x0060 | Grant Descriptor Tuple. A tuple value of Transaction Type ID/Description, |
| | used to describe specific grants issued to an Entity by another |
| | Entity. This field is used to describe the Capabilities Model, which allows |
| | Entities to grant capabilities to other entities. This tuple also includes the |
| | grant subject type, the grant object type, and auxiliary subject types. Each |
| | of these types define a type of artifact or entity required for a grant |
| | following this descriptor to be valid. |
| 0x0061 | Grant Description. A human-readable description of a grant, or a unique |
| | identifier to a translation table that can be used to describe a grant in any |
| | language. |
| 0x0062 | Grant Subject Type. This 128-bit UUID is optional and defines the |
| | expected type of the subject entity that can perform a given transaction. |
| 0x0063 | Grant Object Type. This 128-bit UUID is optional and defines the |
| | expected type of the object artifact upon which a given transaction is to be |
| | performed. |
| 0x0064 | Grant Transaction Type. This 128-bit UUID is optional and explicitly |
| | defines the type of transaction that the entity may perform on the artifact. |
| | Combined, these three field types can be used to perform a primitive sort of |
| | contract. |
| 0x0065 | Grant Tuple. A tuple value of Grant ID/Subject UUID/Object UUID |
| | used to assign a given grant to a given Entity in the context of a given |
| | object. Optional auxiliary UUIDs can be specified as long as the given |
| | auxiliary type UUIDs are defined in the descriptor tuple for this grant type. |
| 0x0066 | Grant Subject. This 128-bit UUID defines the subject, or grantee, of a |
| | grant. |
| 0x0067 | Grant Object. This 128-bit UUID defines the object of a grant. The |
| | grantor must have appropriate capabilities over this object in order for this |
| | grant to be valid. Typically, this is contractually enforced as a “delegation” |
| | grant for a given capability. |
| 0x0068 | Grant Auxiliary Type 1. This 128-bit UUID defines an auxiliary type |
| | required in the grant descriptor tuple relationship. |
| 0x0069 | Grant Auxiliary Type 2. This 128-bit UUID defines an auxiliary type |
| | required in the grant descriptor tuple relationship. |
| 0x006A | Grant Auxiliary Type 3. This 128-bit UUID defines an auxiliary type |
| | required in the grant descriptor tuple relationship. |
| 0x006B | Grant Auxiliary Type 4, This 128-bit UUID defines an auxiliary type |
| | required in the grant descriptor tuple relationship. |
| 0x006C | Grant Auxiliary 1. This 128-bit UUID defines an auxiliary required in the |
| | grant tuple. |
| 0x006D | Grant Auxiliary 2. This 128-bit UUID defines an auxiliary required in the |
| | grant tuple. |
| 0x006E | Grant Auxiliary 3. This 128-bit UUID defines an auxiliary required in the |
| | grant tuple. |
| 0x006F | Grant Auxiliary 4. This 128-bit UUID defines an auxiliary required in the |
| | grant tuple. |
| 0x0070 | Artifact Type State Transition Tuple. This tuple type contains a Previous |
| | State, Next State, Transaction Type ID, and Contract Bytecode fields. |
| 0x0071 | User Field Mapping. This tuple type contains a Transaction Type ID, and a |
| | sequence of Field Mapping Tuple values. |
| 0x0072 | Field Mapping Tuple. This tuple type contains a Short Field Type and a |
| | Long Field Type value. |
| 0x0073 | Contract Bytecode. Bytecode used to enforce a transition from one state to |
| | another in a transaction. |
| 0x0074 | Short Field Type. Unsigned 16-bit Big Endian. |
| 0x0075 | Long Field Type. 128-bit UUID. |
| 0x0076 | Transaction Type UUID. |
| 0x0080 | Block UUID. The UUID for this Block. |
| 0x0081 | Previous Block UUID. The UUID for the previous Block. |
| 0x0082 | Previous Block Hash. The one-way hash for the previous block. This hash |
| | encompasses the entire block, including signature tuples and signature. |
| | The hash algorithm depends upon the cryptography suite defined for this |
| | blockchain. |
| 0x0083 | Block Height. Unsigned Big-Endian 64-bit integer. The current height of |
| | the blockchain. This number increment monotonically for every block. |
| | The Root Block's height is considered 0, so the first Block appended to this |
| | blockchain is assigned a height of 1, the second 2, and so on. |
| 0x0084 | Wrapped Transaction Tuple. This data type wraps a transaction that has |
| | been submitted to this block. |
| 0x0085 | Block Signature Tuple. This tuple contains all signatures except the last |
| | signature that canonizes the block. Each signature in the tuple is |
| | progressive, meaning that it is computed over the previous signatures. At |
| | the beginning of the block append operation, the simple majority of block |
| | agents is known, and the Block Signature Tuple size is pre-computed. |
| | Each signature is appended to this tuple block as each agent votes, and each |
| | signature progressively covers the entire block including the data from |
| | previous signatures. The Block Signature Tuple consists entirely of Signer |
| | UUID and Signature fields. |
| . . . | . . . |
| 0x03FF | The end of Velo reserved predefined fields. |
| 0x0400 | The first user-defined long field. Fields in this range are mapped to |
| | external UUID values by the Entity Type Transactions. |
| . . . | . . . |
| 0xFEFF | The last user-defined long field. Fields in this range are mapped to external |
| | UUID values by the Entity Type Transactions. |
| 0xFF00 | Reserved begin upper range for Velo Certificate Field Types. Reserved for |
| | future extension of the Velo Certificate Format. |
| 0xFFFE | Reserved end upper range for Velo Certificate Field Types. Reserved for |
| | future extension of the Velo Certificate Format. |
| 0xFFFF | Invalid Field Type Sentry Value. |

### Certificate Types

Currently, four certificate types are defined for the Velo Blockchain: the root block, the root entity create transaction, the block transaction, and the transaction. A fifth certificate type is defined, but does not appear in the blockchain; the private entity certificate.

There are three transaction types here. The root entity create transaction is the only transaction type that can be self-signed. This transaction both creates the root entity and is signed by the root entity. The block transaction is special in that it is both a container of transactions, and it has multiple signers. Finally, the general transaction certificate is used for all other transactions within the system.

The Root Block is the only artifact within the system which is not defined as a transaction. The Root Block is created in a special state—the immutable state—which cannot be changed. The Root Block is the only eternal artifact within the system. The Root entity is scoped entirely within the Root Block. The Root entity is considered destroyed within the state of the initial system. The Root Block is hard-coded into each client communicating within a given blockchain, and its signature should be verified as part of the process of connecting to a given system. If the root signature is different between two peers, then so are their world views. This is an irreconcilable difference, and is an runtime error which must be resolved by immediately disconnecting from the given peer.

Because the Root entity's lifetime is scoped to the Root Block, it must create all entities required to bootstrap a given blockchain. Additionally, Root must grant all capabilities required for these entities to operate. Capabilities are one of the properties verified by contracts within the system. The initial contracts that define the system, as well as base transaction types necessary to evolve the system beyond the root block state. Aside from a few axioms defined by the Velo Blockchain, Root is responsible for creating any additional knowledge required for bootstrapping.

| Certificate Type UUID | Description |
|---|---|
| a231383d-a63d-4743- | Root Block. This is the first block in the block |
| 86aa-61fb03a38f39 | chain, in which the root entity is defined, as |
| | well as any top-level grants made by root. This |
| | block is signed by root, and is the only scope |
| | within the system in which the root entity is |
| | allowed to create transactions. The delegating |
| | grants that root issues when it creates child |
| | entities are the only grants that root can make. |
| 1f2e615b-585b-46cc- | Root Entity Create Transaction. This is a |
| 9ffc-95d618c11b92 | special transaction that is only used by root to |
| | create itself, as proof against infinite regress. It |
| | is the only transaction that can be self-signed |
| | within the system. |
| b5fc204c-f544-4c30- | Root Entity Destroy Transaction. This is a |
| a53b-c97bbd33b8c6 | special transaction that is only used by root to |
| | destroy itself, as the last transaction in a Root |
| | Block. |
| 734eacd2-8b13-4a37- | Block Transaction. A block transaction is a |
| aa02-bef5628a6c68 | special type of transaction that includes |
| | multiple signers. For a block to be canonical, |
| | the number of signers must be >= the simple |
| | majority of block agents. |
| 52a7f0fb-8a6b-4d03- | Transaction. The basic building block for all |
| 86a5-7f612fcf7eff | data within the blockchain. Transactions |
| | change the state of artifacts within the |
| | blockchain, from an initial created state to a |
| | final destroyed state. |
| 814e6a74-87aa-4595- | Private Entity. This certificate type does not |
| 9d31-bcc627cfe44e | appear in the blockchain or this document. It is |
| | used as a container for entity secrets, and must |
| | be encrypted at rest. |

### Unique Identifiers

Each Identifier within the system must be unique. There are five reserved Certificate Identifiers in the system. It is an error to use these identifiers to create new transactions, artifacts, entities, blocks, or types. However, the wildcard identifiers can be used in certain contexts, such as grants and contracts.

| Identifier | Meaning |
|---|---|
| 00000000-0000-0000-0000- | NULL wildcard identifier. Matches against |
| 000000000000 | nothing. |
| ffffffff-ffff-ffff-ffff- | ALL wildcard identifier. Matches anything. |
| ffffffffffff | |
| fefefefe-fefe-fefe-fefe- | Error identifier. Indicates an error. |
| fefefefefefe | |
| 60b6d47c-0fb6-4307-807c- | Root identifier. The ID of the Root Entity. |
| d96e2d8c9289 | |
| c09f6dff-5c5f-468a-a3bf- | Artifact Type Type Identifier. |
| 12f4e92761df | |

### Artifact Life Cycle

Before describing Transactions, we should consider the life cycle of Artifacts and, by extension, Entities within the system. When an artifact is created, it is defined with a known state: Created (0x0000). The artifact can go through many state transitions, but all artifacts eventually move into the Destroyed state (0xFFFE), at which point, no further transactions for a given artifact are accepted. For the sake of describing state transitions, a third state, Void (0xFFFF) is defined. This provides us with the ability to map a unique set of rules for each state transition, including custom contracts.

A well-defined artifact has a state graph in which each state is connected to the Created state and the Destroyed state. It is an error to create an artifact in which any state cannot be reached from Created or Destroyed.

The following transactions are defined for each artifact. Contracts can be defined for these transactions. Additional state transitions and transactions can be defined through an Artifact Type Create transaction or an Artifact Type Enrich transaction. Note that there can be more than one Destroy transaction for a given artifact.

| Previous State | Next State | Transaction |
|---|---|---|
| 0xFFFF | 0x0000 | Create |
| . . . | . . . | . . . |
| . . . | 0xFFFE | Destroy |

### Transaction

The Transaction is the main type of certificate encountered in the Velo blockchain. A Transaction modifies the state of an Artifact. It is also possible to have an “enrichment” transaction which maps an Artifact from its current state back to its current state, but provides additional information that “enriches” the data available for an Artifact. However, typically, a Transaction moves an Artifact from one state to another. The first transaction creates an Artifact by changing its state from the Void state to the Created state, literally pulling the object from the Void and into the blockchain. The last transaction destroys an Artifact by changing its state to Destroyed. Between these two transactions can be zero or more transactions over the lifespan of an Artifact.

Transactions are accepted if they pass the axiomatic rules for transactions and also any custom contracts defined for a given transaction. Examples of axiomatic rules are that the transaction must map the current Artifact state to the state defined by the transaction and the previous transaction must be specified by the current transaction. Examples of rules enforced by contracts might include a capabilities check for the entity performing the transaction to ensure that the entity has the right to perform the given transaction on this artifact.

Every Transaction contains the fields in the following table. In addition to these fields are user-defined fields which are mapped based on details provided by the Artifact Type Artifact.

| | Field | |
|---|---|---|
| Field Type | Code | Description |
| Cert Version | 0x0001 | Certificate Format Version. |
| Transaction | 0x0010 | Timestamp for this transaction. |
| Timestamp | | |
| Crypto Suite | 0x0020 | The cryptographic suite used for this |
| | | certificate. |
| Cert Type | 0x0030 | 52a7f0fb-8a6b-4d03-86a5-7f612fcf7eff |
| Transaction | 0x0038 | Unique Transaction Identifier. |
| ID | | |
| Transaction | 0x0039 | Previous Transaction Identifier for this |
| Link | | Artifact. |
| Transaction | 0x0076 | Transaction Type ID. |
| Type | | |
| Artifact ID | 0x0041 | The Artifact to which this transaction refers. |
| Previous State | 0x0042 | The previous state that this artifact was in. |
| | | Must match system record. |
| Next State | 0x0043 | The new state to which this transaction is |
| | | transitioning this artifact. |
| . . . | . . . | . . . |
| Signer ID | 0x0050 | The 128-bit UUID of the signer. |
| Signature | 0x0051 | The signature for this transaction. |

### Artifact Creation Transaction

The Artifact Creation Transaction is the first transaction on record for a given artifact. This transaction extends the Transaction certificate with the given fields. The Previous State and Next State fields are hard-coded to the Void state and the Created state. This transaction, effectively, pulls a new Artifact instance from the void.

| | Field | |
|---|---|---|
| Field Type | Code | Description |
| Artifact | 0x0040 | The type of Artifact being created. |
| Type ID | | |
| Previous State | 0x0042 | 0xFFFF |
| Next State | 0x0043 | 0x0000 |

### Entity Creation Transaction

Entities are Artifacts with keys. The Entity Creation Transaction extends the Artifact Creation Transaction with the public encryption and signing keys for this entity.

| | Field | |
|---|---|---|
| Field Type | Code | Description |
| Public | 0x0052 | The public encryption key for this entity. |
| Encryption | | |
| Key | | |
| Public | 0x0053 | The public signing key for this entity. |
| Signing Key | | |

### Artifact Type Create and Enrich Transactions

The Artifact Type Create and Artifact Type Enrich Transactions are transactions that describe an Artifact Type. These transactions define fields that can be described in transactions modifying artifacts, the transactions that map between one state and the next, and the contracts used to enforce transactions made against these artifacts.

Both transactions are built up by the same fields. When conflicting data is made available in an Enrich transaction, this data supersedes data in the Create transaction. For instance, it is possible to Enrich an Artifact Type with a new state, a new transaction for moving between states, or a new contract for transactions.

There are two major tuples provided in these transactions. The first, the State Transition tuple, is a field containing fields describing the state transition, the transaction responsible for this state transition, and the contract bytecode used to enforce this transition. The second, the User Field Mapping tuple, describes the user fields that can be mapped in a particular transaction for an Artifact. Both the long field type (128-bit UUID) and the short field type (unsigned 16-bit Big Endian integer) are mapped in Field Mappings. Optionally, a Description can be provided for this mapping. This Description can be either a UTF-8 string representing the English language description of this field, or a UUID+offset for an internationalization artifact describing this field in one or more native languages.

The Artifact Type Create transaction is an Artifact Create transaction, in which the Artifact Type and Artifact ID are equal. The Artifact Type Enrich transaction is a transaction on the Artifact Type mapping the created state onto itself (0x0000-→0x0000), which adds or replaces one or more State Transition tuples or User Field Mapping tuples. Note that previous field mappings and contracts are considered valid up until this transaction is applied. Enrichments respect temporal constraints on records. In the blockchain, the order of transactions matter.

The following table describes the basic layout of the Artifact Type Create and Artifact Type Enrich transactions.

| | Field | |
|---|---|---|
| Field Type | Code | Description |
| Artifact | 0x0040 | the Artifact Type being created or enriched. |
| Type ID | | |
| State | 0x0070 | One or more State Transition Tuples, describing |
| Transition | | how transactions are mapped from one state to |
| Tuple | | the next and the contract bytecode to execute. |
| User Field | | |
| Mapping | 0x0071 | The mapping of unique 128-bit UUID values to |
| Tuple | | 16-bit short field type values. |

### State Transition Type

The State Transition Tuple defines which transaction type is used to transition from one state to another, as well as the contract bytecode enforcing this transition. The tuple fields are defined in the following table.

| | Field | |
|---|---|---|
| Field Type | Code | Description |
| From State | 0x0042 | The from state for this transition. |
| To State | 0x0043 | The to state for this transition. |
| Transaction | 0x0076 | The Transaction Type ID for this transition. |
| Type ID | | |
| Contract | 0x0073 | The bytecode for the contract enforcing this |
| Bytecode | | transition. |

### User Field Mapping and Field Mapping Tuple

The User Field Mapping Tuple wraps the Field Mapping Tuple with a Transaction Type ID. The Field Mapping Tuple provides a mechanism to map unique field types, defined as UUID values, to short field type codes, which are emitted in the Velo Certificate format. This keeps the tagged format for Velo Certificates compact while providing near unlimited extensibility. Contracts are defined using the long field types, so this mapping also works to tie the contracts to the data provided in Velo certificates. Additionally, this field mapping is used to enforce which user fields may be present in a certificate. The number of occurrences, the relative order of occurrences, and other constraints are defined in the contract code.

The first table shows the User Field Mapping Tuple outer wrapper.

| | Field | |
|---|---|---|
| Field Type | Code | Description |
| Transaction | 0x0076 | The Transaction Type ID of this mapping. |
| Type ID | | |
| Field | 0x0072 | Zero or more occurrences of the Field Mapping |
| Mapping | | Tuple. |
| Tuple | | |

The second table shows the inner Field Mapping Tuple.

| | Field | |
|---|---|---|
| Field Type | Code | Description |
| Short Field | 0x0074 | The short field type embedded in the certificate. |
| Type | | |
| Long Field | 0x0075 | The long field type referenced by user code. |
| Type | | |

### Block Transaction

The Block Transaction is a special type of transaction that contains other transactions. This transaction updates global state by canonizing local transactions. For a Block Transaction to be valid, it must be signed by the majority of Block Agent Entities in the blockchain. Unlike a regular transaction, it has both a Block Signature Tuple and a normal signer UUID/signature pair at the end of the structure. If there are more than 1400 block agents in a given block cluster, then multiple block signature tuples can be used.

The Block Transaction is very similar to the Transaction type as the following fields demonstrate.

| | Field | |
|---|---|---|
| Field Type | Code | Description |
| Cert Version | 0x0001 | Certificate Formal Version. |
| Transaction | 0x0010 | Timestamp for this transaction. |
| Timestamp | | |
| Crypto Suite | 0x0020 | The cryptographic suite used for this |
| | | certificate. |
| Cert Type | 0x0030 | 734eacd2-8b13-4a37-aa02-bef5628a6c68 |
| Block ID | 0x0080 | Unique Block Identifier. |
| Block Link | 0x0081 | Previous Block Identifier in the chain. |
| Block Height | 0x0082 | The current height of the blockchain. |
| Block Hash | 0x0083 | Previous block hash. |
| Block Height | 0x0084 | Block Height. |
| Wrapped | 0x0085 | This field occurs once per transaction in |
| Transaction | | this Block. |
| Block | 0x0086 | A tuple containing all of the voting signatures |
| Signature | | of Block Agents regarding this Block. |
| Tuple | | |
| Signer ID | 0x0050 | The 128-bit UUID of the signer. |
| Signature | 0x0051 | The final signature canonizing this block. |

### Example Blockchain

The following example blockchain should provide some context for the previous sections of this document. This example is a simple payment disbursement system. This example blockchain is pretty constrained and is not meant as a real-world example. For one thing, the number of top-level entities and the power of these top-level entities has been significantly reduced in order to keep this example simple. A production blockchain would include more entities with the power to revoke and re-create entities, so that keys could be rotated over time. Second, contracts are not defined in this example. Contracts enforce transaction constraints. In this example, appropriate contracts are implied.

The following paragraphs describe at a high-level the flow that will be described through the rest of this section.

The Root Entity creates a Root Block in which some top-level entities are defined: the Block Manager, the initial Block Agent, the Contract Manager, the Payer Manager, and the Payee Manager. The Artifact Type Type is defined and then enriched to give the Contract Manager the ability to enrich artifact types. Artifact? Entity Types are created for each of the top-level entities, as well as the Payer Entity Type, the Payee Entity Type, and the Payment Artifact Type. Finally, the Root Entity creates a transaction to destroy itself, and then canonizes the Root Block by signing it.

Behind the scenes, private key certificates are created for the Block Manager, the initial Block Agent, the Contract Manager, the Payer Manager, and the Payee Manager. These private key certificates are distributed to these entities outside of the blockchain.

In the first Block, the Acme Corp. Payer is created, as well as the Wile E. Coyote Payee. Behind the scenes, private keys are distributed to each of these entities.

In the second Block, Acme Corp. creates a Payment for $1000, which is sent to Wile E. Coyote.

In the third Block, this payment is Posted.

In the fourth Block, this payment is Accepted by Wile E. Coyote.

In the fifth Block, this payment is Completed, and enters the Destroyed state.

### Root Block

The Root Block is constructed in this section. First, we define individual transactions, then roll these into the Root Block proper. The Root Block is made up of the following transactions:

### 1. Create Root Entity.

### 2. Create Artifact Type Type.

### 3. Create Block Manager Entity Type.

### 4. Create Block Manager Entity.

### 5. Create Block Agent Entity Type.

### 6. Create Block Agent Entity.

### 7. Create Contract Manager Entity Type.

### 8. Create Contract Manager Entity.

### 9. Enrich Artifact Type Type.

### 10. Create Payer Manager Entity Type.

### 11. Create Payer Manager Entity.

### 12. Create Payee Manager Entity Type.

### 13. Create Payee Manager Entity.

### 14. Create Payer Entity Type.

### 15. Create Payee Entity Type.

### 16. Create Payment Artifact Type

### 17. Destroy Root Entity.

### Create Root Entity

The Root Entity creates itself via a self-signed entity certificate. This entity will exist only for the duration of the following transactions.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 1f2e615b-585b-46cc-9ffc-95d618c11b92 |
| Transaction ID | 0x0038 | 5d28ab39-6f6f-4d02-b5fe-d58914ce5a4e |
| Transaction | 0x0039 | 00000000-0000-0000-0000-000000000000 |
| Link | | |
| Transaction | 0x0076 | 1f2e615b-585b-46cc-9ffc-95d618c11b92 |
| Type | | |
| Artifact ID | 0x0041 | 60b6d47c-0fb6-4307-807c-d96e2d8c9289 |
| Previous State | 0x0042 | 0xFFFF |
| Next State | 0x0043 | 0x0000 |
| Public | 0x0052 | |
| Encryption | | |
| Key | | |
| Public | 0x0053 | |
| Signing Key | | |
| Signer ID | 0x0050 | 60b6d47c-0fb6-4307-807c-d96e2d8c9289 |
| Signature | 0x0051 | |

### Create Artifact Type Type

The Root Entity next creates the Artifact Type Artifact Type. This meta-type describes all Artifact Types. This meta-type also defines the Artifact Type Create and Artifact Type Enrich transactions, which are used by the Root Entity to create new Artifact and Entity types.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 3dc55f89-cc4e-4804-a08b-3fd0f1baa6ae |
| Transaction | 0x0039 | 00000000-0000-0000-0000-000000000000 |
| Link | | |
| Transaction | 0x0076 | c09f6dff-5c5f-468a-a3bf-12f4e92761df |
| Type | | |
| Artifact Type | 0x0040 | c09f6dff-5c5f-468a-a3bf-12f4e92761df |
| Artifact ID | 0x0041 | c09f6dff-5c5f-468a-a3bf-12f4e92761df |
| Previous State | 0x0042 | 0xFFFF |
| Next State | 0x0043 | 0x0000 |
| Artifact Type | 0x0070 | Create Artifact Type Transaction Tuple (below) |
| Txn Tuple | | |
| Artifact Type | 0x0070 | Enrich Artifact Type Transaction Tuple (below) |
| Txn Tuple | | |
| Artifact Type | 0x0070 | Destroy Artifact Type Transaction Tuple |
| Txn Tuple | | (below) |
| Signer ID | 0x0050 | 60b6d47c-0fb6-4307-807c-d96e2d8c9289 |
| Signature | 0x0051 | |

As part of this meta-transaction, there are three transactions that can be defined for Artifact Types: Create, Enrich, and Destroy. The tuples associated with these transactions are defined below.

TABLE 16
Create Artifact Type

| | Field | |
|---|---|---|
| Field Type | Code | Description |
| From State | 0x0042 | 0xFFFF |
| To State | 0x0043 | 0x0000 |
| Transaction | 0x0076 | 62b2d686-7153-43d7-bd2c-911b20b73a8b |
| Type ID | | |
| Contract | 0x0073 | |
| Bytecode | | |

TABLE 17
Enrich Artifact Type

| | Field | |
|---|---|---|
| Field Type | Code | Description |
| From State | 0x0042 | 0x0000 |
| To State | 0x0043 | 0x0000 |
| Transaction | 0x0076 | 826e8b99-d931-4ee2-aa41-097a00be1935 |
| Type ID | | |
| Contract | 0x0073 | |
| Bytecode | | |

TABLE 18
Destroy Artifact Type

| | Field | |
|---|---|---|
| Field Type | Code | Description |
| From State | 0x0042 | 0x0000 |
| To State | 0x0043 | 0xFFFE |
| Transaction | 0x0076 | 3f5128eb-7925-400e-b4ff-fe5d7fab174d |
| Type ID | | |
| Contract | 0x0073 | |
| Bytecode | | |

### Create Block Manager Entity Type

Next, the Root Entity creates the Block Manager Entity Type. This is the type of the Block Manager created in the next subsection.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 75e28057-f469-4eab-8c45-ac57ece4d1f6 |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | 1134603f-cd90-489b-a450-b6c63fb89803 |
| Previous State | 0x0042 | 0xFFFF |
| Next State | 0x0043 | 0x0000 |
| Artifact Type | 0x0070 | Create Block Manager Transaction Tuple |
| Txn Tuple | | (below) |
| Artifact Type | 0x0070 | Destroy Block Manager Transaction Tuple |
| Txn Tuple | | (below) |
| Signer ID | 0x0050 | 60b6d47c-0fb6-4307-807c-d96e2d8c9289 |
| Signature | 0x0051 | |

Two transactions are defined for Block Manager Entities: Create and Destroy.

TABLE 20
Create Block Manager

| | Field | |
|---|---|---|
| Field Type | Code | Description |
| From State | 0x0042 | 0xFFFF |
| To State | 0x0043 | 0x0000 |
| Transaction | 0x0076 | 17adab83-b33a-47d6-8d5e-784d68abd2af |
| Type ID | | |
| Contract | 0x0073 | |
| Bytecode | | |

TABLE 21
Destroy Block Manager

| | Field | |
|---|---|---|
| Field Type | Code | Description |
| From State | 0x0042 | 0x0000 |
| To State | 0x0043 | 0xFFFE |
| Transaction | 0x0076 | 31404939-0990-43e3-97e7-9d61f5eaff71 |
| Type ID | | |
| Contract | 0x0073 | |
| Bytecode | | |

### Create Block Manager Entity

Next, the Root Entity creates the Block Manager Entity. This entity will be granted the ability to create new Block Agent entities.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 41551a30-dad7-4c5d-bcb7-4416ebcceb26 |
| Transaction | 0x0039 | 00000000-0000-0000-0000-000000000000 |
| Link | | |
| Transaction | 0x0076 | 17adab83-b33a-47d6-8d5e-784d68abd2af |
| Type | | |
| Artifact Type | 0x0040 | 1134603f-cd90-489b-a450-b6c63fb89803 |
| Artifact ID | 0x0041 | a0385e31-9227-412a-b73f-b515f8164129 |
| Previous State | 0x0042 | 0xFFFF |
| Next State | 0x0043 | 0x0000 |
| Public | 0x0052 | |
| Encryption | | |
| Key | | |
| Public Signing | 0x0053 | |
| Key | | |
| Signer ID | 0x0050 | 60b6d47c-0fb6-4307-807c-d96e2d8c9289 |
| Signature | 0x0051 | |

### Create Block Agent Entity Type

Next, the Root Entity creates the Block Agent Entity Type. This is the entity type of Block Agents in this example. Three transactions are provided for this type: create and destroy. The Block Manager created in the previous subsection is granted the ability to create and destroy Block Agent entities via these transactions.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 234262af-d37d-4f09-83dd-7aa21e039f1 |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | 40ca830d-1a7d-434e-82da-129d4a6c7abb |
| Previous State | 0x0042 | 0xFFFF |
| Next State | 0x0043 | 0x0000 |
| Artifact Type | 0x0070 | Create Block Agent Transaction Tuple |
| Txn Tuple | | (below) |
| Artifact Type | 0x0070 | Destroy Block Agent Transaction Tuple |
| Txn Tuple | | (below) |
| Grant Desc | 0x0060 | Grant Descriptor for Create Block Agent |
| Tuple | | (below) |
| Grant Desc | 0x0060 | Grant Descriptor for Destroy Block Agent |
| Tuple | | (below) |
| Grant Tuple | 0x0065 | Explicit Create Grant for Block Manager |
| | | (below) |
| Grant Tuple | 0x0065 | Explicit Destroy Grant for Block Manager |
| | | (below) |
| Signer ID | 0x0050 | 60b6d47c-0fb6-4307-807c-d96e2d8c9289 |
| Signature | 0x0051 | |

Two transactions are defined for Block Agent Entities: Create and Destroy.

TABLE 24
Create Block. Agent

| | Field | |
|---|---|---|
| Field Type | Code | Description |
| From State | 0x0042 | 0xFFFF |
| To State | 0x0043 | 0x0000 |
| Transaction | 0x0076 | 5ed890e4-77a6-443e-84dd-3cb2517f1153 |
| Type ID | | |
| Contract | 0x0073 | |
| Bytecode | | |

TABLE 25
Destroy Block Agent

| | Field | |
|---|---|---|
| Field Type | Code | Description |
| From State | 0x0042 | 0x0000 |
| To State | 0x0043 | 0xFFFE |
| Transaction | 0x0076 | 21595b86-be71-4d81-b779-c750f93aeb44 |
| Type ID | | |
| Contract | 0x0073 | |
| Bytecode | | |

The following grant descriptor tuples restrict the types of entities and artifacts involved in the above transactions.

TABLE 26
Grant Descriptor for Create Block Agent

| | Field | |
|---|---|---|
| Field Type | Code | Description |
| Txn Type | 0x0076 | 5ed890e4-77a6-443e-84dd-3cb2517f1153 |
| Grant Desc | 0x0061 | “Create Block Agent” |
| Subject Type | 0x0062 | 1134603f-cd90-489b-a450-b6c63fb89803 |
| Object Type | 0x0063 | 40ca830d-1a7d-434e-82da-129d4a6c7abb |

TABLE 27
Grant Descriptor for Destroy Block Agent

| | Field | |
|---|---|---|
| Field Type | Code | Description |
| Txn Type | 0x0076 | 21595b86-be71-4d81-b779-c750f93aeb44 |
| Grant Desc | 0x0061 | “Destroy Block Agent” |
| Subject Type | 0x0062 | 1134603f-cd90-489b-a450-b6c63fb89803 |
| Object Type | 0x0063 | 40ca830d-1a7d-434e-82da-129d4a6c7abb |

The following grant tuples provide explicit grants to the Block Manager for creating and destroying Block Agents.

TABLE 28
Grant for Create Block Agent

| | Field | |
|---|---|---|
| Field Tepe | Code | Description |
| Txn Type | 0x0076 | 5ed890e4-77a6-443e-84dd-3cb2517f1153 |
| Subject | 0x0066 | a0385e31-9227-412a-b73f-b515f8164129 |
| Object | 0x0067 | ffffffff-ffff-ffff-ffff-ffffffffffff |

TABLE 29
Grant for Destroy Block Agent

| | Field | |
|---|---|---|
| Field Type | Code | Description |
| Txn Type | 0x0076 | 21595b86-be71-4d81-b779-c750f93aeb44 |
| Subject | 0x0066 | a0385e31-9227-412a-b73f-b515f8164129 |
| Object | 0x0067 | ffffffff-ffff-ffff-ffff-ffffffffffff |

### Create Block Agent Entity

Next, the Root Entity creates the initial Block Agent Entity.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | a5d2f7f6-db55-4f11-8df8-c1a676cc3684 |
| Transaction | 0x0039 | 00000000-0000-0000-0000-000000000000 |
| Link | | |
| Transaction | 0x0076 | 5ed890e4-77a6-443e-84dd-3cb2517f1153 |
| Type | | |
| Artifact Type | 0x0040 | 40ca830d-1a7d-434e-82da-129d4a6c7abb |
| Artifact ID | 0x0041 | 4b8d61ec-7362-482f-a13c-7348c6c508ff |
| Previous State | 0x0042 | 0xFFFF |
| Next State | 0x0043 | 0x0000 |
| Public | 0x0052 | |
| Encryption | | |
| Public Signing | 0x0053 | |
| Key | | |
| Signer ID | 0x0050 | 60b6d47c-0fb6-4307-807c-d96e2d8c9289 |
| Signature | 0x0051 | |

### Create Contract Manager Entity Type

Next, the Root Entity creates the Contract Manager Entity Type. This is the type associated with the Contract Manager.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | b9b0fa8c-d351-4b7c-b3ec-4d82d43e1a12 |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | 8fdaa908-afc6-4a07-93c2-5f0d9e4979d1 |
| Previous State | 0x0042 | 0xFFFF |
| Next State | 0x0043 | 0x0000 |
| Artifact Type | 0x0070 | Create Contract Manager Transaction |
| Txn Tuple | | Tuple (below) |
| Artifact Type | 0x0070 | Destroy Contract Manager Transaction |
| Txn Tuple | | Tuple (below) |
| Signer ID | 0x0050 | 60b6d47c-0fb6-4307-807c-d96e2d8c9289 |
| Signature | 0x0051 | |

Two transactions are defined for Contract Manager Entities: Create and Destroy.

TABLE 32
Create Contract Manager

| | Field | |
|---|---|---|
| Field Type | Code | Description |
| From State | 0x0042 | 0xFFFF |
| To State | 0x0043 | 0x0000 |
| Transaction | 0x0076 | e38a87db-6d30-41ea-9dde-9bf2d3242495 |
| Type ID | | |
| Contract | 0x0073 | |
| Bytecode | | |

TABLE 33
Destroy Contract Manager

| | Field | |
|---|---|---|
| Field Type | Code | Description |
| From State | 0x0042 | 0x0000 |
| To State | 0x0043 | 0xFFFE |
| Transaction | 0x0076 | 935b4173-f203-4263-b4ff-db7671dceb73 |
| Type ID | | |
| Contract | 0x0073 | |
| Bytecode | | |

### Create Contract Manager Entity

Next, the Root Entity creates the Contract Manager Entity. This entity will be granted the power to create and enrich artifact types.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 9af8a9a1-aa90-47f4-bd90-1672980498a5 |
| Transaction | 0x0039 | 00000000-0000-0000-0000-000000000000 |
| Link | | |
| Transaction | 0x0076 | 5ed890e4-77a6-443e-84dd-3cb2517f1153 |
| Type | | |
| Artifact Type | 0x0040 | 8fdaa908-afc6-4a07-93c2-5f0d9e4979d1 |
| Artifact ID | 0x0041 | b9cc01d5-d67f-4679-8ef6-d592f60b0f91 |
| Previous State | 0x0042 | 0xFFFF |
| Next State | 0x0043 | 0x0000 |
| Public | 0x0052 | |
| Encryption | | |
| Key | | |
| Public Signing | 0x0053 | |
| Key | | |
| Signer ID | 0x0050 | 60b6d47c-0fb6-4307-807c-d96e2d8c9289 |
| Signature | 0x0051 | |

### Enrich Artifact Type Type

Now that we have a Contract Manager entity, the Root Entity enriches the Artifact Type Type to grant this Contract Manager the ability to create new artifact types and enrich current artifact types.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 1d2c1ac3-a556-426e-93ab-6e60bcd77054 |
| Transaction | 0x0039 | 3dc55f89-cc4e-4804-a08b-3fd0f1baa6ae |
| Link | | |
| Transaction | 0x0076 | 826e8b99-d931-4ee2-aa41-097a00be1935 |
| Type | | |
| Artifact ID | 0x0041 | c09f6dff-5c5f-468a-a3bf-12f4e92761df |
| Previous State | 0x0042 | 0x0000 |
| Next State | 0x0043 | 0x0000 |
| Grant Desc | 0x0060 | Grant Descriptor for Create Artifact |
| Tuple | | Type (below) |
| Grant Desc | 0x0060 | Grant Descriptor for Enrich Artifact |
| Tuple | | Type (below) |
| Grant Desc | 0x0060 | Grant Descriptor for Destroy Artifact |
| Tuple | | Type (below) |
| Grant Tuple | 0x0065 | Explicit Create Grant for Artifact Type |
| | | (below) |
| Grant Tuple | 0x0065 | Explicit Enrich Grant for Artifact Type |
| | | (below) |
| Grant Tuple | 0x0065 | Explicit Destroy Grant for Artifact Type |
| | | (below) |
| Signer ID | 0x0050 | 60b6d47c-0fb6-4307-807c-d96e2d8c9289 |
| Signature | 0x0051 | |

The following grant descriptor tuples restrict the types of entities and artifacts involved in the above transactions.

TABLE 36
Grant Descriptor for Create Artifact Type

| | Field | |
|---|---|---|
| Field Type | Code | Description |
| Txn Type | 0x0076 | 62b2d686-7153-43d7-bd2c-911b20b73a8b |
| Grant Desc | 0x0061 | “Create Artifact Type” |
| Subject Type | 0x0062 | 8fdaa908-afc6-4a07-93c2-5f0d9e4979d1 |
| Object Type | 0x0063 | c09f6dff-5c5f-468a-a3bf-12f4e92761df |

TABLE 37
Grant Descriptor for Enrich Artifact Type

| | Field | |
|---|---|---|
| Field Type | Code | Description |
| Txn Type | 0x0076 | 826e8b99-d931-4ee2-aa41-097a00be1935 |
| Grant Desc | 0x0061 | “Enrich Artifact Type” |
| Subject Type | 0x0062 | 8fdaa908-afc6-4a07-93c2-5f0d9e4979d1 |
| Object Type | 0x0063 | c09f6dff-5c5f-468a-a3bf-12f4e92761df |

TABLE 38
Grant Descriptor for Destroy Artifact Type

| | Field | |
|---|---|---|
| Field Type | Code | Description |
| Txn Type | 0x0076 | 3f5128eb-7925-400e-b4ff-fe5d7fab174d |
| Grant Desc | 0x0061 | “Destroy Artifact Type” |
| Subject Type | 0x0062 | 8fdaa908-afc6-4a07-93c2-5f0d9e4979d1 |
| Object Type | 0x0063 | c09f6dff-5c5f-468a-a3bf-12f4e92761df |

The following grant tuples provide explicit grants to the Contract Manager for creating, enriching, and destroying Artifact Types.

TABLE 39
Grant for Create Artifact Type

| | Field | |
|---|---|---|
| Field Type | Code | Description |
| Txn Type | 0x0076 | 62b2d686-7153-43d7-bd2c-911b20b73a8b |
| Subject | 0x0066 | b9cc01d5-d67f-4679-8ef6-d592f60b0f91 |
| Object | 0x0067 | ffffffff-ffff-ffff-ffff-ffffffffffff |

TABLE 40
Grant for Enrich Artifact Type

| | Field | |
|---|---|---|
| Field Type | Code | Description |
| Txn Type | 0x0076 | 826e8b99-d931-4ee2-aa41-097a00be1935 |
| Subject | 0x0066 | b9cc01d5-d67f-4679-8ef6-d592f60b0f91 |
| Object | 0x0067 | ffffffff-ffff-ffff-ffff-ffffffffffff |

TABLE 41
Grant for Destroy Artifact Type

| | Field | |
|---|---|---|
| Field Type | Code | Description |
| Txn Type | 0x0076 | 3f5128eb-7925-400e-b4ff-fe5d7fab174d |
| Subject | 0x0066 | b9cc01d5-d67f-4679-8ef6-d592f60b0f91 |
| Object | 0x0067 | ffffffff-ffff-ffff-ffff-ffffffffffff |

Create Payer Manager Entity Type

The Payer Manager is responsible for onboarding Payer in this system. This transaction defines the entity type for Payer Managers.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 90848ff2-a3ee-44f2-9e60-4ece1af4058e |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | cc11d1c1-c473-41ce-bd36-7ba23a8b8b1a |
| Previous State | 0x0042 | 0xFFFF |
| Next State | 0x0043 | 0x0000 |
| Artifact Type | 0x0070 | Create Payer Manager Transaction Tuple |
| Txn Tuple | | (below) |
| Artifact Type | 0x0070 | Destroy Payer Manager Transaction Tuple |
| Txn Tuple | | (below) |
| Signer ID | 0x0050 | 60b6d47c-0fb6-4307-807c-d96e2d8c9289 |
| Signature | 0x0051 | |

Two transactions are defined for Payer Manager Entities: Create and Destroy.

TABLE 43
Create Payer Manager

| | Field | |
|---|---|---|
| Field Type | Code | Description |
| From State | 0x0042 | 0xFFFF |
| To State | 0x0043 | 0x0000 |
| Transaction | 0x0076 | b443f54f-ed1e-45fe-b04f-c8d5a9618e12 |
| Type ID | | |
| Contract | 0x0073 | |
| Bytecode | | |

TABLE 44
Destroy Payer Manager

| | Field | |
|---|---|---|
| Field Type | Code | Description |
| From State | 0x0042 | 0x0000 |
| To State | 0x0043 | 0xFFFE |
| Transaction | 0x0076 | 30925766-139c-4bde-aee5-be1f2b5f8846 |
| Type ID | | |
| Contract | 0x0073 | |
| Bytecode | | |

### Create Payer Manager Entity

Below is the transaction that creates the Payer Manager Entity, which on-boards new Payers into the blockchain.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 5d09debd-3f72-4aa7-968a-99573ec59463 |
| Transaction | 0x0039 | 00000000-0000-0000-0000-000000000000 |
| Link | | |
| Transaction | 0x0076 | b443f54f-ed1e-45fe-b04f-c8d5a9618e12 |
| Type | | |
| Artifact Type | 0x0040 | cc11d1c1-c473-41ce-bd36-7ba23a8b8b1a |
| Artifact ID | 0x0041 | 4d07155f-d9cb-456d-aafa-93e5c82a4905 |
| Previous State | 0x0042 | 0xFFFF |
| Next State | 0x0043 | 0x0000 |
| Public | 0x0052 | |
| Encryption | | |
| Key | | |
| Public Signing | 0x0053 | |
| Key | | |
| Signer ID | 0x0050 | 60b6d47c-0fb6-4307-807c-d96e2d8c9289 |
| Signature | 0x0051 | |

### Create Payee Manger Entity Type

The Payee Manager is responsible for on-boarding Payees in this system. This transaction defines the entity type for Payee Managers.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 00f1100a-fc54-45c3-8a3b-6a71d77e6b05 |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | bada6f65-130c-4be8-b8ab-f5111827c76a |
| Previous State | 0x0042 | 0xFFFF |
| Next State | 0x0043 | 0x0000 |
| Artifact Type | 0x0070 | Create Payee Manager Transaction |
| Txn Tuple | | Tuple (below) |
| Artifact Type | 0x0070 | Destroy Payee Manager Transaction |
| Txn Tuple | | Tuple (below) |
| Signer ID | 0x0050 | 60b6d47c-0fb6-4307-807c-d96e2d8c9289 |
| Signature | 0x0051 | |

Two transactions are defined for Payee Manager Entities: Create and Destroy.

TABLE 47
Create Payee Manager

| | Field | |
|---|---|---|
| Field Type | Code | Description |
| From State | 0x0042 | 0xFFFF |
| To State | 0x0043 | 0x0000 |
| Transaction | 0x0076 | 2dc1b1cb-8bb3-4a8a-9975-c18dbb5e4497 |
| Type ID | | |
| Contract | 0x0073 | |
| Bytecode | | |

TABLE 48
Destroy Payee Manager

| | Field | |
|---|---|---|
| Field Type | Code | Description |
| From State | 0x0042 | 0x0000 |
| To State | 0x0043 | 0xFFFE |
| Transaction | 0x0076 | 19ed85a6-114b-4c2c-9043-5abc20046886 |
| Type ID | | |
| Contract | 0x0073 | |
| Bytecode | | |

### Create Payee Manager Entity

Below is the transaction that creates the Payee Manager Entity, which on-boards new Payees into the blockchain.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 5b010f31-af97-4826-8538-dfd4badc5c22 |
| Transaction | 0x0039 | 00000000-0000-0000-0000-000000000000 |
| Link | | |
| Transaction | 0x0076 | 2dc1b1cb-8bb3-4a8a-9975-c18dbb5e4497 |
| Type | | |
| Artifact Type | 0x0040 | bada6f65-130c-4be8-b8ab-f5111827c76a |
| Artifact ID | 0x0041 | c94fe92b-08a9-4ab1-a278-d70b891aa375 |
| Previous State | 0x0042 | 0xFFFF |
| Next State | 0x0043 | 0x0000 |
| Public | 0x0052 | |
| Encryption | | |
| Key | | |
| Public Signing | 0x0053 | |
| Key | | |
| Signer ID | 0x0050 | 60b6d47c-0fb6-4307-807c-d96e2d8c9289 |
| Signature | 0x0051 | |

### Create Payer Entity Type

The Payer Entity Type is used for modeling Payers.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | 6f2d00d7-a6f8-4b6a-8ef9-4fce3b380f61 |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | 916ff152-861d-4b91-9f84-90d0e8aaf536 |
| Previous State | 0x0042 | 0xFFFF |
| Next State | 0x0043 | 0x0000 |
| Artifact Type | 0x0070 | Create Payer Transaction Tuple (below) |
| Txn Tuple | | |
| Artifact Type | 0x0070 | Update Payer Transaction Tuple (below) |
| Txn Tuple | | |
| Artifact Type | 0x0070 | Destroy Payer Transaction Tuple (below) |
| Txn Tuple | | |
| Grant Desc | 0x0060 | Grant Descriptor for Create Payer |
| Tuple | | (below) |
| Grant Desc | 0x0060 | Grant Descriptor for Update Payer |
| Tuple | | (below) |
| Grant Desc | 0x0060 | Grant Descriptor for Destroy Payer |
| Tuple | | (below) |
| Grant Tuple | 0x0065 | Explicit Create Grant for Payer (below) |
| Grant Tuple | 0x0065 | Explicit Update Grant for Payer (below) |
| Grant Tuple | 0x0065 | Explicit Destroy Grant for Payer (below) |
| User Field | 0x0071 | User Field Mapping for Create Payer |
| Mapping | | (below) |
| User Field | 0x0071 | User Field Mapping for Update Payer |
| Mapping | | (below) |
| Signer ID | 0x0050 | 60b6d47c-0fb6-4307-807c-d96e2d8c9289 |
| Signature | 0x0051 | |

Three transactions are defined for Payer Entities: Create, Update, and Destroy.

TABLE 51
Create Payer

| | Field | |
|---|---|---|
| Field Type | Code | Description |
| From State | 0x0042 | 0xFFFF |
| To State | 0x0043 | 0x0000 |
| Transaction | 0x0076 | 8523b89d-52a7-45a8-8cf6-889e0f2dc144 |
| Type ID | | |
| Contract | 0x0073 | |
| Bytecode | | |

TABLE 52
Update Payer

| | Field | |
|---|---|---|
| Field Type | Code | Description |
| From State | 0x0042 | 0x0000 |
| To State | 0x0043 | 0x0000 |
| Transaction | 0x0076 | 8da0f7e9-3051-4fc5-968f-1ca672bb3670 |
| Type ID | | |
| Contract | 0x0073 | |
| Bytecode | | |

TABLE 53
Destroy Payer

| | Field | |
|---|---|---|
| Field Type | Code | Description |
| From State | 0x0042 | 0x0000 |
| To State | 0x0043 | 0xFFFE |
| Transaction | 0x0076 | f8587e62-a4cd-47d0-9539-c0edff0aa315 |
| Type ID | | |
| Contract | 0x0073 | |
| Bytecode | | |

The following grant descriptor tuples restrict the types that can be used for grants involving Payers. Only Payer Managers can create, update, or destroy Payers.

TABLE 54
Grant Descriptor for Create Payer

| | Field | |
|---|---|---|
| Field Type | Code | Description |
| Txn Type | 0x0076 | 8523b89d-52a7-45a8-8cf6-889e0f2dc144 |
| Grant Desc | 0x0061 | “Create Payer” |
| Subject Type | 0x0062 | cc11d1c1-c473-41ce-bd36-7ba23a8b8b1a |
| Object Type | 0x0063 | 916ff152-861d-4b91-9f84-90d0e8aaf536 |

TABLE 55
Grant Descriptor for Update Payer

| | Field | |
|---|---|---|
| Field Type | Code | Description |
| Txn Type | 0x0076 | 8da0f7c9-3051-4fc5-968f-1ca672bb3670 |
| Grant Desc | 0x0061 | “Update Payer” |
| Subject Type | 0x0062 | cc11d1c1-c473-41ce-bd36-7ba23a8b8b1a |
| Object Type | 0x0063 | 916ff152-861d-4b91-9f84-90d0e8aaf536 |

TABLE 56
Grant Descriptor for Destroy Payer

| | Field | |
|---|---|---|
| Field Type | Code | Description |
| Txn Type | 0x0076 | f8587e62-a4cd-47d0-9539-c0edff0aa315 |
| Grant Desc | 0x0061 | “Destroy Payer” |
| Subject Type | 0x0062 | cc11d1c1-c473-41ce-bd36-7ba23a8b8b1a |
| Object Type | 0x0063 | 916ff152-861d-4b91-9f84-90d0e8aaf536 |

The following grant tuples provide explicit grants to the Payer Manager for creating, updating, and destroying Payers.

TABLE 57
Grant for Create Payer

| | Field | |
|---|---|---|
| Field Type | Code | Description |
| Txn Type | 0x0076 | 8523b89d-52a7-45a8-8cf6-889e0f2dc144 |
| Subject | 0x0066 | 4d07155f-d9cb-456d-aafa-93e5c82a4905 |
| Object | 0x0067 | ffffffff-ffff-ffff-ffff-ffffffffffff |

TABLE 58
Grant for Update Payer

| | Field | |
|---|---|---|
| Field Type | Code | Description |
| Txn Type | 0x0076 | 8da0f7e9-3051-4fc5-968f-1ca672bb3670 |
| Subject | 0x0066 | 4d07155f-d9cb-456d-aafa-93e5c82a4905 |
| Object | 0x0067 | ffffffff-ffff-ffff-ffff-ffffffffffff |

TABLE 59
Grant for Destroy Payer

| | Field | |
|---|---|---|
| Field Type | Code | Description |
| Txn Type | 0x0076 | f8587e62-a4cd-47d0-9539-c0edff0aa315 |
| Subject | 0x0066 | 4d07155f-d9cb-456d-aafa-93e5c82a4905 |
| Object | 0x0067 | ffffffff-ffff-ffff-ffff-ffffffffffff |

Two user field mappings are defined for the Create Payer and Update Payer transactions. These field mappings allow user-defined fields to be mapped to these transactions.

TABLE 60
User Field Mapping for Create Payer

| | Field | |
|---|---|---|
| Field Type | Code | Description |
| Txn Type | 0x0076 | 8523b89d-52a7-45a8-8cf6-889e0f2dc144 |
| Field | 0x0072 | Field Mapping for EIN Fingerprint (below) |
| Mapping | | |
| Field | 0x0072 | Field Mapping for Payer Name (below) |
| Mapping | | |
| Field | 0x0072 | Field Mapping for Payer Address (below) |
| Mapping | | |
| Field | 0x0072 | Field Mapping for Payer Country (below) |
| Mapping | | |

TABLE 61
User Field Mapping for Update Payer

| | Field | |
|---|---|---|
| Field Type | Code | Description |
| Txn Type | 0x0076 | 8da0f7c9-3051-4fc5-968f-1ca672bb3670 |
| Field | 0x0072 | Field Mapping for EIN Fingerprint (below) |
| Mapping | | |
| Field | 0x0072 | Field Mapping for Payer Name (below) |
| Mapping | | |
| Field | 0x0072 | Field Mapping for Payer Address (below) |
| Mapping | | |
| Field | 0x0072 | Field Mapping for Payer Country (below) |
| Mapping | | |

Both of the User Field Mapping tuples above contain verbatim the following field mappings.

TABLE 62
Field Mapping for Payer EIN Fingerprint

| | Field | |
|---|---|---|
| Field Type | Code | Description |
| Short Field | 0x0074 | 0x0400 |
| Type | | |
| Long Field | 0x0075 | f54432a8-6571-41de-a9bb-b410502ef951 |
| Type | | |

TABLE 63
Field Mapping for Payer Name

| | Field | |
|---|---|---|
| Field Type | Code | Description |
| Short Field | 0x0074 | 0x0401 |
| Type | | |
| Long Field | 0x0075 | 28a01a5b-311f-40b3-bad2-3c16dff7cf17 |
| Type | | |

TABLE 64
Field Mapping for Payer Address

| | Field | |
|---|---|---|
| Field Type | Code | Description |
| Short Field | 0x0074 | 0x0402 |
| Type | | |
| Long Field | 0x0075 | 967e976f-79d5-413c-88c5-cfeffd49171e |
| Type | | |

TABLE 65
Field Mapping for Payer Country

| | Field | |
|---|---|---|
| Field Type | Code | Description |
| Short Field | 0x0074 | 0x0403 |
| Type | | |
| Long Field | 0x0075 | 4b36c169-d0e5-425d-958b-70d9d7b9cfe1 |
| Type | | |

### Create Payee Entity Type

The Payee Entity Type is used for modeling Payees.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction | 0x0038 | b16287d8-3cf0-43d1-bb81-8597b10d5c76 |
| ID | | |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | 5cc7c328-dca3-4aa6-a916-86e7e61ae153 |
| Previous State | 0x0042 | 0xFFFF |
| Next State | 0x0043 | 0x0000 |
| Artifact Type | 0x0070 | Create Payee Transaction Tuple (below) |
| Txn Tuple | | |
| Artifact Type | 0x0070 | Update Payee Transaction Tuple (below) |
| Txn Tuple | | |
| Artifact Type | 0x0070 | Destroy Payee Transaction Tuple (below) |
| Txn Tuple | | |
| Grant Desc | 0x0060 | Grant Descriptor for Create Payee (below) |
| Tuple | | |
| Grant Desc | 0x0060 | Grant Descriptor for Update Payee (below) |
| Tuple | | |
| Grant Desc | 0x0060 | Grant Descriptor for Destroy Payee (below) |
| Tuple | | |
| Grant Tuple | 0x0065 | Explicit Create Grant for Payee (below) |
| Grant Tuple | 0x0065 | Explicit Update Grant for Payee (below) |
| Grant Tuple | 0x0065 | Explicit Destroy Grant for Payee (below) |
| User Field | 0x0071 | User Field Mapping for Create Payee (below) |
| Mapping | | |
| User Field | 0x0071 | User Field Mapping for Update Payee (below) |
| Mapping | | |
| Signer ID | 0x0050 | 60b6d47c-0fb6-4307-807c-d96e2d8c9289 |
| Signature | 0x0051 | |

Three transactions are defined for Payee Entities: Create, Update, and Destroy.

TABLE 67
Create Payee

| | Field | |
|---|---|---|
| Field Type | Code | Description |
| From State | 0x0042 | 0xFFFF |
| To State | 0x0043 | 0x0000 |
| Transaction | 0x0076 | 968c6e48-bcc7-4444-bf7c-7919800d491b |
| Type ID | | |
| Contract | 0x0073 | |
| Bytecode | | |

TABLE 68
Update Payee

| | Field | |
|---|---|---|
| Field Type | Code | Description |
| From State | 0x0042 | 0x0000 |
| To State | 0x0043 | 0x0000 |
| Transaction | 0x0076 | ac1f0c07-9f20-47bb-afd6-b510d7b92882 |
| Type ID | | |
| Contract | 0x0073 | |
| Bytecode | | |

TABLE 69
Destroy Payee

| | Field | |
|---|---|---|
| Field Type | Code | Description |
| From State | 0x0042 | 0x0000 |
| To State | 0x0043 | 0xFFFE |
| Transaction | 0x0076 | 6c363242-e270-4536-ae42-687b604c88c0 |
| Type ID | | |
| Contract | 0x0073 | |
| Bytecode | | |

The following grant descriptor tuples restrict the types that can be used for grants involving Payees Only Payee Managers can create, update, or destroy Payers.

TABLE 70
Grant Descriptor for Create Payee

| | Field | |
|---|---|---|
| Field Type | Code | Description |
| Txn Type | 0x0076 | 968c6e48-bcc7-4444-bf7c-7919800d491b |
| Grant Desc | 0x0061 | “Create Payee” |
| Subject Type | 0x0062 | bada6f65-130c-4be8-b8ab-f5111827c76a |
| Object Type | 0x0063 | 5cc7c328-dca3-4aa6-a916-86e7e61ae153 |

TABLE 71
Grant Descriptor for Update Payee

| | Field | |
|---|---|---|
| Field Type | Code | Description |
| Txn Type | 0x0076 | ac1f0c07-9f20-47bb-afd6-b510d7b92882 |
| Grant Desc | 0x0061 | “Update Payee” |
| Subject Type | 0x0062 | bada6f65-130e-4be8-b8ab-f5111827c76a |
| Object Type | 0x0063 | 5cc7c328-dca3-4aa6-a916-86e7e61ae153 |

TABLE 72
Grant Descriptor for Destroy Payee

| | Field | |
|---|---|---|
| Field Type | Code | Description |
| Txn Type | 0x0076 | 6c363242-e270-4536-ae42-687b604c88c0 |
| Grant Desc | 0x0061 | “Destroy Payee” |
| Subject Type | 0x0062 | bada6f65-130c-4be8-b8ab-f5111827c76a |
| Object Type | 0x0063 | 5cc7c328-dca3-4aa6-a916-86e7e61ae153 |

The following grant tuples provide explicit grants to the Payee Manager for creating, updating, and destroying Payees.

TABLE 73
Grant for Create Payee

| | Field | |
|---|---|---|
| Field Type | Code | Description |
| Txn Type | 0x0076 | 968c6e48-bcc7-4444-bf7c-7919800d491b |
| Subject | 0x0066 | c94fe92b-08a9-4ab1-a278-d70b891aa375 |
| Object | 0x0067 | ffffffff-ffff-ffff-ffff-ffffffffffff |

TABLE 74
Grant for Update Payee

| | Field | |
|---|---|---|
| Field Type | Code | Description |
| Txn Type | 0x0076 | ac1f0c07-9f20-47bb-afd6-b510d7b92882 |
| Subject | 0x0066 | c94fe92b-08a9-4ab1-a278-d70b891aa375 |
| Object | 0x0067 | ffffffff-ffff-ffff-ffff-ffffffffffff |

TABLE 75
Grant for Destroy Payee

| | Field | |
|---|---|---|
| Field Type | Code | Description |
| Txn Type | 0x0076 | 6c363242-e270-4536-ae42-687b604c88c0 |
| Subject | 0x0066 | c94fe92b-08a9-4ab1-a278-d70b891aa375 |
| Object | 0x0067 | ffffffff-ffff-ffff-ffff-ffffffffffff |

Two user field mappings are defined for the Create Payee and Update Payee transactions. These field mappings allow user-defined fields to be mapped to these transactions.

TABLE 76
User Field Mapping for Create Payee

| | Field | |
|---|---|---|
| Field Type | Code | Description |
| Txn Type | 0x0076 | 968c6e48-bcc7-4444-bf7c-7919800d491b |
| Field | 0x0072 | Field Mapping for SSN Fingerprint (below) |
| Mapping | | |
| Field | 0x0072 | Field Mapping for Payee Name (below) |
| Mapping | | |
| Field | 0x0072 | Field Mapping for Payee Address (below) |
| Mapping | | |
| Field | 0x0072 | Field Mapping for Payee Country (below) |
| Mapping | | |

TABLE 77
User Field Mapping for Update Payee

| | Field | |
|---|---|---|
| Field Type | Code | Description |
| Txn Type | 0x0076 | ac1f0c07-9f20-47bb-afd6-b510d7b92882 |
| Field | 0x0072 | Field Mapping for SSN Fingerprint (below) |
| Mapping | | |
| Field | 0x0072 | Field Mapping for Payee Name (below) |
| Mapping | | |
| Field | 0x0072 | Field Mapping for Payee Address (below) |
| Mapping | | |
| Field | 0x0072 | Field Mapping for Payee Country (below) |
| Mapping | | |

Both of the User Field Mapping tuples above contain verbatim the following field mappings.

TABLE 78
Field Mapping for Payee SSN Fingerprint

| | Field | |
|---|---|---|
| Field Type | Code | Description |
| Short Field | 0x0074 | 0x0400 |
| Type | | |
| Long Field | 0x0075 | 2c3991b5-a716-48b0-807e-d84ef8034e70 |
| Type | | |

TABLE 79
Field Mapping for Payee Name

| | Field | |
|---|---|---|
| Field Type | Code | Description |
| Short Field | 0x0074 | 0x0401 |
| Type | | |
| Long Field | 0x0075 | 525d5cbf-baa1-4246-bd0d-6ed774dd75cd |
| Type | | |

TABLE 80
Field Mapping for Payee Address

| | Field | |
|---|---|---|
| Field Type | Code | Description |
| Short Field | 0x0074 | 0x0402 |
| Type | | |
| Long Field | 0x0075 | 52583fd5-762a-44e6-926d-fe3ca7ceb7c4 |
| Type | | |

TABLE 81
Field Mapping for Payee Country

| | Field | |
|---|---|---|
| Field Type | Code | Description |
| Short Field | 0x0074 | 0x0403 |
| Type | | |
| Long Field | 0x0075 | f3a12a5c-019e-4378-8185-bbe5bd698360 |
| Type | | |

### Create Payment Artifact Type

The Payment Artifact Type is used to track disbursements from Payers to Payees.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction | 0x0038 | fa2c1603-0218-47b4-ab9f-b9d505f01a25 |
| ID | | |
| Transaction | 0x0039 | 00000000-0000-0000-0000-000000000000 |
| Link | | |
| Transaction | 0x0076 | 62b2d686-7153-43d7-bd2c-911b20b73a8b |
| Type | | |
| Artifact Type | 0x0040 | c09f6dff-5c5f-468a-a3bf-12f4e92761df |
| Artifact ID | 0x0041 | 74966734-d901-4c13-9775-c0358abf51f7 |
| Previous State | 0x0042 | 0xFFFF |
| Next State | 0x0043 | 0x0000 |
| Artifact Type | 0x0070 | Create Payment Transaction Tuple (below) |
| Txn Tuple | | |
| Artifact Type | 0x0070 | Post Payment Transaction Tuple (below) |
| Txn Tuple | | |
| Artifact Type | 0x0070 | Receive Payment Transaction Tuple (below) |
| Txn Tuple | | |
| Artifact Type | 0x0070 | Complete Payment Transaction Tuple (below) |
| Txn Tuple | | |
| Artifact Type | 0x0070 | Cancel Payment Transaction Tuple (below) |
| Txn Tuple | | |
| Artifact Type | 0x0070 | Refund Payment Transaction Tuple (below) |
| Txn Tuple | | |
| Artifact Type | 0x0070 | Delete Payment Transaction Tuple (below) |
| Txn Tuple | | |
| Grant Desc | 0x0060 | Grant Descriptor for Create Payment (below) |
| Tuple | | |
| Grant Desc | 0x0060 | Grant Descriptor for Post Payment (below) |
| Tuple | | |
| Grant Desc | 0x0060 | Grant Descriptor for Receive Payment (below) |
| Tuple | | |
| Grant Desc | 0x0060 | Grant Descriptor for Complete Payment |
| Tuple | | (below) |
| Grant Desc | 0x0060 | Grant Descriptor for Cancel Payment (below) |
| Tuple | | |
| Grant Desc | 0x0060 | Grant Descriptor for Refund Payment (below) |
| Tuple | | |
| Grant Desc | 0x0060 | Grant Descriptor for Delete Payment (below) |
| Tuple | | |
| Grant Tuple | 0x0065 | Implicit Grant for Create Payment (below) |
| Grant Tuple | 0x0065 | Implicit Grant for Post Payment (below) |
| Grant Tuple | 0x0065 | Implicit Grant for Receive Payment (below) |
| Grant Tuple | 0x0065 | Implicit Grant for Complete Payment (below) |
| Grant Tuple | 0x0065 | Implicit Grant for Cancel Payment (below) |
| Grant Tuple | 0x0065 | Implicit Grant for Refund Payment (below) |
| Grant Tuple | 0x0065 | Implicit Grant for Delete Payment (below) |
| User Field | 0x0071 | User Field Mapping for Create Payment |
| Mapping | | (below) |
| User Field | 0x0071 | User Field Mapping for Post Payment (below) |
| Mapping | | |
| User Field | 0x0071 | User Field Mapping for Receive Payment |
| Mapping | | (below) |
| User Field | 0x0071 | User Field Mapping for Complete Payment |
| Mapping | | (below) |
| User Field | 0x0071 | User Field Mapping for Cancel Payment |
| Mapping | | (below) |
| User Field | 0x0071 | User Field Mapping for Refund Payment |
| Mapping | | (below) |
| User Field | 0x0071 | User Field Mapping for Delete Payment |
| Mapping | | (below) |
| Signer ID | 0x0050 | 60b6d47c-0fb6-4307-807c-d96e2d8c9289 |
| Signature | 0x0051 | |

Seven transactions are defined for Payment Artifacts: Create, Post, Receive, Complete, Cancel, Refund, and Delete.

TABLE 83
Create Payment

| | Field | |
|---|---|---|
| Field Type | Code | Description |
| From State | 0x0042 | 0xFFFF |
| To State | 0x0043 | 0x0000 |
| Transaction | 0x0076 | 9a228ec4-0a78-458e-8489-ba41085851ca |
| Type ID | | |
| Contract | 0x0073 | |
| Bytecode | | |

TABLE 84
Post Payment

| | Field | |
|---|---|---|
| Field Type | Code | Description |
| From State | 0x0042 | 0x0000 |
| To State | 0x0043 | 0x0001 |
| Transaction | 0x0076 | 9911c6f4-b882-4533-8ebc-d44674a14d20 |
| Type ID | | |
| Contract | 0x0073 | |
| Bytecode | | |

TABLE 85
Receive Payment

| | Field | |
|---|---|---|
| Field Type | Code | Description |
| From State | 0x0042 | 0x0001 |
| To State | 0x0043 | 0x0002 |
| Transaction | 0x0076 | 707c5e1f-fb6e-4b7c-8d8c-5f72133327fb |
| Type ID | | |
| Contract | 0x0073 | |
| Bytecode | | |

TABLE 86
Complete Payment

| | Field | |
|---|---|---|
| Field Type | Code | Description |
| From State | 0x0042 | 0x0002 |
| To State | 0x0043 | 0xFFFE |
| Transaction | 0x0076 | 708f2438-9551-4196-bb4f-772956acb78d |
| Type ID | | |
| Contract | 0x0073 | |
| Bytecode | | |

TABLE 87
Cancel Payment

| | Field | |
|---|---|---|
| Field Type | Code | Description |
| From State | 0x0042 | 0x0001 |
| To State | 0x0043 | 0xFFFE |
| Transaction | 0x0076 | f01b4748-5ebc-45ad-b20f-db6ddb3affb1 |
| Type ID | | |
| Contract | 0x0073 | |
| Bytecode | | |

TABLE 88
Refund Payment

| | Field | |
|---|---|---|
| Field Type | Code | Description |
| From State | 0x0042 | 0x0002 |
| To State | 0x0043 | 0xFFFE |
| Transaction | 0x0076 | 157bfcf3-17c3-4119-a87a-54145288d288 |
| Type ID | | |
| Contract | 0x0073 | |
| Bytecode | | |

TABLE 89
Delete Payment

| | Field | |
|---|---|---|
| Field Type | Code | Description |
| From State | 0x0042 | 0x0000 |
| To State | 0x0043 | 0xFFFE |
| Transaction | 0x0076 | 35d703f5-27ea-4536-a749-8d056342d9a2 |
| Type ID | | |
| Contract | 0x0073 | |
| Bytecode | | |

The following grant descriptor tuples restrict the types that can be used for grants involving Payments. Only a Payer can create, post, complete, delete, or cancel a Payment. Only a Payee can receive or refund a Payment.

TABLE 90
Grant Descriptor for Create Payment

| | Field | |
|---|---|---|
| Field Type | Code | Description |
| Txn Type | 0x0076 | 9a228ec4-0a78-458e-8489-ba41085851ca |
| Grant Desc | 0x0061 | “Create Payment” |
| Subject Type | 0x0062 | 916ff152-861d-4b91-9f84-90d0e8aaf536 |
| Object Type | 0x0063 | 74966734-d901-4c13-9775-c0358abf51f7 |
| Aux1 Type | 0x0068 | 5cc7c328-dca3-4aa6-a916-86e7e61ae153 |

TABLE 91
Grant Descriptor for Post Payment

| | Field | |
|---|---|---|
| Field Type | Code | Description |
| Txn Type | 0x0076 | 9911c6f4-b882-4533-8ebc-d44674a14d20 |
| Grant Desc | 0x0061 | “Post Payment” |
| Subject Type | 0x0062 | 916ff152-861d-4b91-9f84-90d0e8aaf536 |
| Object Type | 0x0063 | 74966734-d901-4c13-9775-c0358abf51f7 |

TABLE 92
Grant Descriptor for Receive Payment

| | Field | |
|---|---|---|
| Field Type | Code | Description |
| Txn Type | 0x0076 | 707c5e1f-fb6e-4b7c-8d8c-5f72133327fb |
| Grant Desc | 0x0061 | “Receive Payment” |
| Subject Type | 0x0062 | 5cc7c328-dca3-4aa6-a916-86e7e61ae153 |
| Object Type | 0x0063 | 74966734-d901-4c13-9775-c0358abf51f7 |

TABLE 93
Grant Descriptor for Complete Payment

| | Field | |
|---|---|---|
| Field Type | Code | Description |
| Txn Type | 0x0076 | 708f2438-9551-4196-bb4f-772956acb78d |
| Grant Desc | 0x0061 | “Complete Payment” |
| Subject Type | 0x0062 | 916ff152-861d-4b91-9f84-90d0e8aaf536 |
| Object Type | 0x0063 | 74966734-d901-4c13-9775-c0358abf51f7 |

TABLE 94
Grant Descriptor for Cancel Payment

| | Field | |
|---|---|---|
| Field Type | Code | Description |
| Txn Type | 0x0076 | f01b4748-5ebc-45ad-b20f-db6ddb3affb1 |
| Grant Desc | 0x0061 | “Cancel Payment” |
| Subject Type | 0x0062 | 916ff152-861d-4b91-9f84-90d0e8aaf536 |
| Object Type | 0x0063 | 74966734-d901-4c13-9775-c0358abf51f7 |

TABLE 95
Grant Descriptor for Refund Payment

| | Field | |
|---|---|---|
| Field Type | Code | Description |
| Txn Type | 0x0076 | 157bfcf3-17c3-4119-a87a-54145288d288 |
| Grant Desc | 0x0061 | “Refund Payment” |
| Subject Type | 0x0062 | 5cc7c328-dca3-4aa6-a916-86e7e61ae153 |
| Object Type | 0x0063 | 74966734-d901-4c13-9775-c0358abf51f7 |

TABLE 96
Grant Descriptor for Delete Payment

| | Field | |
|---|---|---|
| Field Type | Code | Description |
| Txn Type | 0x0076 | 35d703f5-27ea-4536-a749-8d056342d9a2 |
| Grant Desc | 0x0061 | “Delete Payment” |
| Subject Type | 0x0062 | 916ff152-861d-4b91-9f84-90d0e8aaf536 |
| Object Type | 0x0063 | 74966734-d901-4c13-9775-c0358abf51f7 |

The following grant tuples provide implicit grants for Payers and Payees to perform transactions on Payments. The real enforcement of which Payers and Payees can perform which transactions on a given Payment is enforced by the Contract bytecode.

TABLE 97
Grant for Create Payment

| | Field | |
|---|---|---|
| Field Type | Code | Description |
| Txn Type | 0x0076 | 9a228ec4-0a78-458e-8489-ba41085851ca |
| Subject | 0x0066 | ffffffff-ffff-ffff-ffff-ffffffffffff |
| Object | 0x0067 | ffffffff-ffff-ffff-ffff-ffffffffffff |
| Aux1 | 0x006C | ffffffff-ffff-ffff-ffff-ffffffffffff |

TABLE 98
Grant for Post Payment

| | Field | |
|---|---|---|
| Field Type | Code | Description |
| Txn Type | 0x0076 | 9911c6f4-b882-4533-8ebc-d44674a14d20 |
| Subject | 0x0066 | ffffffff-ffff-ffff-ffff-ffffffffffff |
| Object | 0x0067 | ffffffff-ffff-ffff-ffff-ffffffffffff |

TABLE 99
Grant for Receive Payment

| | Field | |
|---|---|---|
| Field Type | Code | Description |
| Txn Type | 0x0076 | 707c5e1f-fb6e-4b7c-8d8c-5f72133327fb |
| Subject | 0x0066 | ffffffff-ffff-ffff-ffff-ffffffffffff |
| Object | 0x0067 | ffffffff-ffff-ffff-ffff-ffffffffffff |

TABLE 100
Grant for Complete Payment

| | Field | |
|---|---|---|
| Field Type | Code | Description |
| Txn Type | 0x0076 | 708f2438-9551-4196-bb4f-772956acb78d |
| Subject | 0x0066 | ffffffff-ffff-ffff-ffff-ffffffffffff |
| Object | 0x0067 | ffffffff-ffff-ffff-ffff-ffffffffffff |

TABLE 101
Grant for Cancel Payment

| | Field | |
|---|---|---|
| Field Type | Code | Description |
| Txn Type | 0x0076 | f01b4748-5ebc-45ad-b20f-db6ddb3affb1 |
| Subject | 0x0066 | ffffffff-ffff-ffff-ffff-ffffffffffff |
| Object | 0x0067 | ffffffff-ffff-ffff-ffff-ffffffffffff |

TABLE 102
Grant for Refund Payment

| | Field | |
|---|---|---|
| Field Type | Code | Description |
| Txn Type | 0x0076 | 157bfcf3-17c3-4119-a87a-54145288d288 |
| Subject | 0x0066 | ffffffff-ffff-ffff-ffff-ffffffffffff |
| Object | 0x0067 | ffffffff-ffff-ffff-ffff-ffffffffffff |

TABLE 103
Grant for Delete Payment

| | Field | |
|---|---|---|
| Field Type | Code | Description |
| Txn Type | 0x0076 | 35d703f5-27ea-4536-a749-8d056342d9a2 |
| Subject | 0x0066 | ffffffff-ffff-ffff-ffff-ffffffffffff |
| Object | 0x0067 | ffffffff-ffff-ffff-ffff-ffffffffffff |

Each of the Payment transactions have custom user field mappings.

TABLE 104
User Field Mapping for Create Payment

| | Field | |
|---|---|---|
| Field Type | Code | Description |
| Txn Type | 0x0076 | 9a228ec4-0a78-458e-8489-ba41085851ca |
| Field | 0x0072 | Field Mapping for Currency Code (below) |
| Mapping | | |
| Field | 0x0072 | Field Mapping for Payment Amount (below) |
| Mapping | | |
| Field | 0x0072 | Field Mapping for Payer UUID (below) |
| Mapping | | |
| Field | 0x0072 | Field Mapping for Payee UUID (below) |
| Mapping | | |

TABLE 105
User Field Mapping for Post Payment

| | Field | |
|---|---|---|
| Field Type | Code | Description |
| Txn Type | 0x0076 | 9911c6f4-b882-4533-8ebc-d44674a14d20 |
| Field | 0x0072 | Field Mapping for Payment Type (below) |
| Mapping | | |

TABLE 106
User Field Mapping for Receive Payment

| | Field | |
|---|---|---|
| Field Type | Code | Description |
| Txn Type | 0x0076 | 707c5e1f-fb6e-4b7c-8d8c-5f72133327fb |
| Field | 0x0072 | Field Mapping for Receive Code (below) |
| Mapping | | |

TABLE 107
User Field Mapping for Complete Payment

| | Field | |
|---|---|---|
| Field Type | Code | Description |
| Txn Type | 0x0076 | 708f2438-9551-4196-bb4f-772956acb78d |
| Field | 0x0072 | Field Mapping for Completion Code (below) |
| Mapping | | |

TABLE 108
User Field Mapping for Cancel Payment

| | Field | |
|---|---|---|
| Field Type | Code | Description |
| Txn Type | 0x0076 | f01b4748-5ebc-45ad-b20f-db6ddb3affb1 |
| Field | 0x0072 | Field Mapping for Cancel Reason Code (below) |
| Mapping | | |

TABLE 109
User Field Mapping for Refund Payment

| | Field | |
|---|---|---|
| Field Type | Code | Description |
| Txn Type | 0x0076 | 157bfcf3-17c3-4119-a87a-54145288d288 |
| Field | 0x0072 | Field Mapping for Refund Reason Code (below) |
| Mapping | | |

TABLE 110
User Field Mapping for Delete Payment

| | Field | |
|---|---|---|
| Field Type | Code | Description |
| Txn Type | 0x0076 | 157bfcf3-17c3-4119-a87a-54145288d288 |
| Field | 0x0072 | Field Mapping for Delete Reason Code (below) |
| Mapping | | |

The following mappings are used in the above transactions.

TABLE 111
Field Mapping for Currency Code

| | Field | |
|---|---|---|
| Field Type | Code | Description |
| Short Field | 0x0074 | 0x0400 |
| Type | | |
| Long Field | 0x0075 | de688f0a-ad76-45fb-af53-e9d05160eb1c |
| Type | | |

TABLE 112
Field Mapping for Payment Amount

| | Field | |
|---|---|---|
| Field Type | Code | Description |
| Short Field | 0x0074 | 0x0401 |
| Type | | |
| Long Field | 0x0075 | f0fc25fd-334a-4404-8a5b-7e3500b05fbb |
| Type | | |

TABLE 113
Field Mapping for Payer UUID

| | Field | |
|---|---|---|
| Field Type | Code | Description |
| Short Field | 0x0074 | 0x0402 |
| Type | | |
| Long Field | 0x0075 | 7de55ba9-836e-4b88-893d-467ef3fa2033 |
| Type | | |

TABLE 114
Field Mapping for Payee UUID

| | Field | |
|---|---|---|
| Field Type | Code | Description |
| Short Field | 0x0074 | 0x0403 |
| Type | | |
| Long Field | 0x0075 | 7e2558f7-c2f4-4f2d-ba9e-c450ce51c64b |
| Type | | |

TABLE 115
Field Mapping for Payment Type

| | Field | |
|---|---|---|
| Field Type | Code | Description |
| Short Field | 0x0074 | 0x0404 |
| Type | | |
| Long Field | 0x0075 | dfd40da2-de99-4090-b663-1540de3dd15e |
| Type | | |

TABLE 116
Field Mapping for Receive Code

| | Field | |
|---|---|---|
| Field Type | Code | Description |
| Short Field | 0x0074 | 0x0405 |
| Type | | |
| Long Field | 0x0075 | 44566b14-975b-494d-a825-8d375449be96 |
| Type | | |

TABLE 117
Field Mapping for Completion Code

| | Field | |
|---|---|---|
| Field Type | Code | Description |
| Short Field | 0x0074 | 0x0406 |
| Type | | |
| Long Field | 0x0075 | 4728ebd1-6bb8-41a2-9d99-5e3c22e095fb |
| Type | | |

TABLE 118
Field Mapping for Cancel Reason Code

| | Field | |
|---|---|---|
| Field Type | Code | Description |
| Short Field | 0x0074 | 0x0407 |
| Type | | |
| Long Field | 0x0075 | 1430b13f-7542-4605-bd69-a5271d19276f |
| Type | | |

TABLE 119
Field Mapping for Refund Reason Code

| | Field | |
|---|---|---|
| Field Type | Code | Description |
| Short Field | 0x0074 | 0x0408 |
| Type | | |
| Long Field | 0x0075 | 2f0ff8d6-ed95-43a7-85eb-da1ef4eed4a9 |
| Type | | |

TABLE 120
Field Mapping for Delete Reason Code

| | Field | |
|---|---|---|
| Field Type | Code | Description |
| Short Field | 0x0074 | 0x0409 |
| Type | | |
| Long Field | 0x0075 | 0de045e0-8aad-4f6b-a4a0-27c5c152347a |
| Type | | |

### Destroy Root Entity

After setting up all transactions, the Root Entity destroys itself. This destruction takes place after all transactions are canonized, which allows the Root Entity to perform one last operation: signing the Root Block, which canonizes all transactions therein.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | b5fc204c-f544-4c30-a53b-c97bbd33b8c6 |
| Transaction ID | 0x0038 | 5d28ab39-6f6f-4d02-b5fe-d58914ce5a4e |
| Transaction | 0x0039 | 1f2e615b-585b-46cc-9ffc-95d618c11b92 |
| Link | | |
| Transaction | 0x0076 | b5fc204c-f544-4c30-a53b-c97bbd33b8c6 |
| Type | | |
| Artifact ID | 0x0041 | 60b6d47c-0fb6-4307-807c-d96e2d8c9289 |
| Previous State | 0x0042 | 0x0000 |
| Next State | 0x0043 | 0xFFFE |
| Signer ID | 0x0050 | 60b6d47c-0fb6-4307-807c-d96e2d8c9289 |
| Signature | 0x0051 | |

### Root Block Transaction

All previous transactions created by the Root Entity are rolled up into the Root Block. This is the initial block in the block chain. Block zero.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | a231383d-a63d-4743-86aa-61fb03a38f39 |
| Block UUID | 0x0080 | a231383d-a63d-4743-86aa-61fb03a38f39 |
| Previous | 0x0081 | 00000000-0000-0000-0000-000000000000 |
| Block UUID | | |
| Block Height | 0x0083 | 0x0000000000000000 |
| Txn Tuple | 0x0084 | Create Root Entity Transaction |
| Txn Tuple | 0x0084 | Create Artifact Type Type Transaction |
| Txn Tuple | 0x0084 | Create Block Manager Entity Type |
| Txn Tuple | 0x0084 | Create Block Manager Entity |
| Txn Tuple | 0x0084 | Create Block Agent Entity Type |
| Txn Tuple | 0x0084 | Create Block Agent Entity |
| Txn Tuple | 0x0084 | Create Contract Manager Entity Type |
| Txn Tuple | 0x0084 | Create Contract Manager Entity |
| Txn Tuple | 0x0084 | Enrich Artifact Type Type |
| Txn Tuple | 0x0084 | Create Payer Manager Entity Type |
| Txn Tuple | 0x0084 | Create Payer Manager Entity |
| Txn Tuple | 0x0084 | Create Payee Manager Entity Type |
| Txn Tuple | 0x0084 | Create Payee Manager Entity |
| Txn Tuple | 0x0084 | Create Payer Entity Type |
| Txn Tuple | 0x0084 | Create Payee Entity Type |
| Txn Tuple | 0x0084 | Create Payment Artifact Type |
| Txn Tuple | 0x0084 | Destroy Root Entity |
| Signer ID | 0x0050 | 60b6d47c-0fb6-4307-807c-d96e2d8c9289 |
| Signature | 0x0051 | |

### Block 1

At some point in the future, a new Payer and a new Payee are created. Acme Corp., the Payer, will be paying Wile E. Coyote, the Payee, promotional fees for trying some new products in his attempts to catch the Road Runner. Acme Corp., decides to give this example blockchain a try, so it contacts the Payer Manager to set up an account, and has Wile E. Coyote contact the Payee Manager to also set up an account.

Create Acme Corp. Payer

The Payer Manager issues a Payer Create Transaction in order to add Acme Corp. to the blockchain. This transaction includes the public portions of Acme Corp.'s key pairs, allowing Acme Corp. to both submit transactions to the blockchain and to perform safe key derivations with Payees, such as Wile E. Coyote, who trusts the details entered into the blockchain. In turn, the Payer Manager verifies Acme Corp.'s details and performs real-world attestation of credentials to ensure that Acme Corp. is the real Acme Corp. before issuing this transaction.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction | 0x0038 | de5a7d79-1192-4fd4-b393-7c20252a9e19 |
| ID | | |
| Transaction | 0x0039 | 00000000-0000-0000-0000-000000000000 |
| Link | | |
| Transaction | 0x0076 | 8523b89d-52a7-45a8-8cf6-889e0f2dc144 |
| Type | | |
| Artifact Type | 0x0040 | 916ff152-861d-4b91-9f84-90d0e8aaf536 |
| Artifact ID | 0x0041 | ced83053-ddf6-4883-938f-d24eb62e7adc |
| Previous State | 0x0042 | 0xFFFF |
| Next State | 0x0043 | 0x0000 |
| Public | 0x0052 | |
| Encryption | | |
| Key | | |
| Public Signing | 0x0053 | |
| Key | | |
| EIN | 0x0400 | One-way derivation of EIN, derivable by |
| Fingerprint | | Payer Manager, and used for verification |
| | | purposes. |
| Payer Name | 0x0401 | “Acme Corporation” |
| Payer Address | 0x0402 | “123 Zenith Way, Walla Walla WA, |
| | | 99362, USA” |
| Payer Country | 0x0403 | 0x0001 (USA) |
| Signer ID | 0x0050 | 4d07155f-d9cb-456d-aafa-93e5c82a4905 |
| Signature | 0x0051 | |

### Create Wile E. Coyote Payee

The Payee Manager issues a Payee Create Transaction in order to add Wile E. Coyote as a Payee to the blockchain. This transaction includes the public portions of Wile E. Coyote's key pairs, allowing Wile E. Coyote to both submit transactions to the blockchain and to perform safe key derivations with Payors, such as Acme Corp., who trusts the details entered into the blockchain. In turn, the Payee Manager verifies Wile E. Coyote's details and performs real-world attestation of credentials to ensure that Wile E. Coyote is who he says he is, before issuing this transaction.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction | 0x0038 | 7918cb6c-5a7e-43f4-9e72-cafddaf5cf23 |
| ID | | |
| Transaction | 0x0039 | 00000000-0000-0000-0000-000000000000 |
| Link | | |
| Transaction | 0x0076 | 968c6e48-bcc7-4444-bf7c-7919800d491b |
| Type | | |
| Artifact Type | 0x0040 | 5cc7c328-dca3-4aa6-a916-86e7e61ae153 |
| Artifact ID | 0x0041 | 0898c1a1-61dc-4bbb-b917-cb5ed6342710 |
| Previous State | 0x0042 | 0xFFFF |
| Next State | 0x0043 | 0x0000 |
| Public | 0x0052 | |
| Encryption | | |
| Key | | |
| Public Signing | 0x0053 | |
| Key | | |
| SSN | 0x0400 | One-way derivation of SSN, derivable |
| Fingerprint | | by Payee Manager, and used for |
| | | verification purposes. |
| Payee Name | 0x0401 | “Wile E. Coyote” |
| Payee Address | 0x0402 | “7441 Sand Cave Road, Phoenix AZ, |
| | | 85035, USA” |
| Payee Country | 0x0403 | 0x0001 (USA) |
| Signer ID | 0x0050 | c94fe92b-08a9-4ab1-a278-d70b891aa375 |
| Signature | 0x0051 | |

### Block 1 Transaction

The transactions in this section are part of a complete Block that is appended to the blockchain. For sake of illustration, we will consider this Block 1. The Block transaction follows. Each of the transactions in this section are submitted to the Block Agent, and the Block Agent decides when and how to form a Block. In a production setting, there would be a large number of Block Agent entities that would vote on the formation of blocks, and a signature block would be included that tallies the vote for each Block Agent. The next Block in the blockchain would be decided by a simple majority vote, which satisfies the Consistency requirement of CAP theorem.

In this example, since there is only one Block Agent entity, the Block Agent signs the Block to canonize it.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 734eacd2-8b13-4a37-aa02-bef5628a6c68 |
| Block UUID | 0x0080 | abdf1719-cb75-491a-8811-563c1b451c92 |
| Previous | 0x0081 | a231383d-a63d-4743-86aa-61fb03a38f39 |
| Block UUID | | |
| Block Height | 0x0083 | 0x0000000000000001 |
| . . . | . . . | . . . |
| Txn Tuple | 0x0084 | Create Acme Corp. Payer |
| . . . | . . . | . . . |
| Txn Tuple | 0x0084 | Create Wile E. Coyote Payee |
| . . . | . . . | . . . |
| Signer ID | 0x0050 | 4b8d61ec-7362-482f-a13c-7348c6c508ff |
| Signature | 0x0051 | |

### Block 2

We arbitrarily choose Block 2 to create a payment from Acme Corp. to Mr. Coyote. We use the Create Payment Transaction defined in the root block, along with the custom mappings defined for the amount and the payee.

Crate Payment from Acme Corp. to Mr. Coyote

As per the grant rules, Acme Corporation creates the payment artifact.

| | Field | |
|---|---|---|
| Field Type | Code | Description |
| Cert Version | 0x0001 | 0x00010000 |
| Transaction | 0x0010 | |
| Timestamp | | |
| Crypto | 0x0020 | 0x0001 |
| Suite | | |
| Cert Type | 0x0030 | 52a7f0fb-8a6b-4d03-86a5-7f612fcf7eff |
| Transaction | 0x0038 | 0c0f2390-22ae-43a8-b7c9-57654ecb279c |
| ID | | |
| Transaction | 0x0039 | 00000000-0000-0000-0000-000000000000 |
| Link | | |
| Transaction | 0x0076 | 9a228ec4-0a78-458e-8489-ba41085851ca |
| Type | | |
| Artifact | 0x0040 | 74966734-d901-4c13-9775-c0358abf51f7 |
| Type | | |
| Artifact ID | 0x0041 | f5cc7127-786a-425b-9110-78d93f8e0267 |
| Previous | 0x0042 | 0xFFFF |
| State | | |
| Next State | 0x0043 | 0x0000 |
| Currency | 0x0400 | 840 (unsigned 16-bit int Big Endian) |
| Code | | |
| Payment | 0x0401 | 100000 ($1000.00 in pennies, as a 64-bit |
| Amount | | unsigned Big Endian value). |
| Payor | 0x0402 | ced83053-ddf6-4883-938f-d24eb62e7adc |
| UUID | | |
| Payee | 0x0403 | 0898c1a1-61dc-4bbb-b917-cb5ed6342710 |
| UUID | | |
| Signer ID | 0x0050 | ced83053-ddf6-4883-938f-d24eb62e7adc |
| Signature | 0x0051 | |

### Block 2 Transaction

The transaction in this section is part of a complete Block that is appended to the blockchain. For sake of illustration, we will consider this Block 2. The Block transaction follows. The Create Payment Transaction is posted to the Block Agent, which then adds this to the next block, and adds this block to the blockchain, along with any other transactions selected for this block.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 734eacd2-8b13-4a37-aa02-bef5628a6c68 |
| Block UUID | 0x0080 | db683ff3-10da-4e84-87ad-5db42a20fe24 |
| Previous | 0x0081 | abdf1719-cb75-491a-8811-563c1b451c92 |
| Block UUID | | |
| Block Height | 0x0083 | 0x0000000000000002 |
| . . . | . . . | . . . |
| Txn Tuple | 0x0084 | Create Payment Transaction |
| . . . | . . . | . . . |
| Signer ID | 0x0050 | 4b8d61ec-7362-482f-a13c-7348c6c508ff |
| Signature | 0x0051 | |

### Block 3

We arbitrarily choose Block 3 to post the payment from Acme Corp. to Mr. Coyote. We use the Post Payment Transaction defined in the root block, along with the custom mappings defined for the payment type.

Post Payment from Acme Corp. To Mr. Coyote

As per the grant rules Acme Corporation posts the payment.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | c403c05c-925b-4745-b4fe-33c872b772e7 |
| Transaction | 0x0039 | 0c0f2390-22ae-43a8-b7c9-57654ecb279c |
| Link | | |
| Transaction | 0x0076 | 9911c6f4-b882-4533-8ebc-d44674a14d20 |
| Type | | |
| Artifact Type | 0x0040 | 74966734-d901-4c13-9775-c0358abf51f7 |
| Artifact ID | 0x0041 | f5cc7127-786a-425b-9110-78d93f8e0267 |
| Previous State | 0x0042 | 0x0000 |
| Next State | 0x0043 | 0x0001 |
| Payment Type | 0x0404 | ACH (some sort of enumeration code) |
| Signer ID | 0x0050 | ced83053-ddf6-4883-938f-d24eb62e7adc |
| Signature | 0x0051 | |

### Block 3 Transaction

The transaction in this section is part of a complete Block that is appended to the blockchain. For sake of illustration, we will consider this Block 3. The Block transaction follows. The Post Payment Transaction is posted to the Block Agent, which then adds this to the next block, and adds this block to the blockchain, along with any other transactions selected for this block.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 734eacd2-8b13-4a37-aa02-bef5628a6c68 |
| Block UUID | 0x0080 | 6b0766a6-0b4c-477f-831b-e04e9cfbd047 |
| Previous | 0x0081 | db683ff3-10da-4e84-87ad -5db42a20fe24 |
| Block UUID | | |
| Block Height | 0x0083 | 0x0000000000000003 |
| . . . | . . . | . . . |
| Txn Tuple | 0x0084 | Post Payment Transaction |
| . . . | . . . | . . . |
| Signer ID | 0x0050 | 4b8d61ec-7362-482f-a13c-7348c6c508ff |
| Signature | 0x0051 | |

### Block 4

We arbitrarily choose Block 4 to receive the payment from Acme Corp. to Mr. Coyote. We use the Receive Payment Transaction defined in the root block, along with the custom mappings defined for the receive code.

Receive Payment from Acme Corp. by Mr. Coyote

As per the grant rules, Mr. Coyote receives the payment.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | a334b574-1461-4859-9f05-984657ee8f98 |
| Transaction | 0x0039 | c403c05c-925b-4745-b4fe-33c872b772e7 |
| Link | | |
| Transaction | 0x0076 | 707c5e1f-fb6e-4b7c-8d8c-5f72133327fb |
| Type | | |
| Artifact Type | 0x0040 | 74966734-d901-4c13-9775-c0358abf51f7 |
| Artifact ID | 0x0041 | f5cc7127-786a-425b-9110-78d93f8e0267 |
| Previous State | 0x0042 | 0x0001 |
| Next State | 0x0043 | 0x0002 |
| Receive Code | 0x0405 | Some code value. |
| Signer ID | 0x0050 | 0898c1a1-61dc-4bbb-b917-cb5ed6342710 |
| Signature | 0x0051 | |

### Block 4 Transaction

The transaction in this section is part of a complete Block that is appended to the blockchain. For sake of illustration, we will consider this Block 4. The Block transaction follows. The Receive Payment Transaction is posted to the Block Agent, which then adds this to the next block, and adds this block to the blockchain, along with any other transactions selected for this block.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 734eacd2-8b13-4a37-aa02-bef5628a6c68 |
| Block UUID | 0x0080 | 05e24476-2c1f-41ae-94c2-6f8d3956be18 |
| Previous | 0x0081 | 6b0766a6-0b4c-477f-831b-e04e9cfbd047 |
| Block UUID | | |
| Block Height | 0x0083 | 0x0000000000000004 |
| . . . | . . . | . . . |
| Txn Tuple | 0x0084 | Receive Payment Transaction |
| Signer ID | 0x0050 | 4b8d61ec-7362-482f-a13c-7348c6c508ff |
| Signature | 0x0051 | |

### Block 5

We arbitrarily choose Block 5 to complete the payment from Acme Corp. to Mr. Coyote. We use the Complete Payment Transaction defined in the root block, along with the custom mappings defined for the completion code. Once the payment artifact reaches Completed, it is considered a “destroyed” artifact, meaning that no further transactions can be applied to it. When Acme Corporation performs the complete payment transaction on this artifact, they are effectively closing out the payment.

Complete Payment from Acme Corp. To Mr. Coyote

As per the grant rules, Acme Corp. completes the payment transaction.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 52a7f0fb-8a6b-4d03-86a5-7f612fcf7eff |
| Transaction ID | 0x0038 | f0e49e03-c74b-4038-9b15-488c9cb39bb7 |
| Transaction | 0x0039 | a334b574-1461-4859-9f05-984657ee8f98 |
| Link | | |
| Transaction | 0x0076 | 708f2438-9551-4196-bb4f-772956acb78d |
| Type | | |
| Artifact Type | 0x0040 | 74966734-d901-4c13-9775-c0358abf51f7 |
| Artifact ID | 0x0041 | f5cc7127-786a-425b-9110-78d93f8e0267 |
| Previous State | 0x0042 | 0x0002 |
| Next Slate | 0x0043 | 0xFFFE |
| Completion | 0x0406 | Some code value. |
| Code | | |
| Signer ID | 0x0050 | ced83053-ddf6-4883-938f-d24eb62e7adc |
| Signature | 0x0051 | |

### Block 5 Transaction

The transaction in this section is part of a complete Block that is appended to the blockchain. For sake of illustration, we will consider this Block 5. The Block transaction follows. The Complete Payment Transaction is posted to the Block Agent, which then adds this to the next block, and adds this block to the blockchain, along with any other transactions selected for this block.

| | Field | |
|---|---|---|
| Field Type | Code | Description |
| Cert Version | 0x0001 | 0x00010000 |
| Transaction | 0x0010 | |
| Timestamp | | |
| Crypto Suite | 0x0020 | 0x0001 |
| Cert Type | 0x0030 | 734eacd2-8b13-4a37-aa02-bef5628a6c68 |
| Block UUID | 0x0080 | 03202c4c-8e14-4755-a1ff-ddc0fc491f5b |
| Previous | 0x0081 | 05e24476-2c1f-41ae-94c2-6f8d3956be18 |
| Block UUID | | |
| Block Height | 0x0083 | 0x0000000000000005 |
| . . . | . . . | . . . |
| Txn Tuple | 0x0084 | Complete Payment Transaction |
| . . . | . . . | . . . |
| Signer ID | 0x0050 | 4b8d61ec-7362-482f-a13c-7348c6c508ff |
| Signature | 0x0051 | |

We claim:

1. A method of performing a transaction using a blockchain comprising:
receiving a connection request from a peer;
verifying that a root block signature of the peer matches local root signature;
responsive to verifying the root block signature, receiving a certificate having one of a plurality of types, the plurality of types including a root block, a root entity create transaction, a block transaction, and a transaction, wherein the transaction type includes a self-signed root entity create transaction;
updating the blockchain to include a new artifact via an artifact creation transaction.

2. The method of claim 1, wherein a universally unique identifier (UUID) of the transaction type is 52a7f0fb-8a6b-4d03-86a5-7f612fcf7eff

3. The method of claim 1, wherein the transaction type certificate includes field types including:
a Certificate Version, a Transaction Timestamp, a Crypto Suite identifying a cryptographic suite used for this certificate, a Certificate Type, a Transaction Identifier, a Transaction Link, a Transaction Type, an
Artifact identifier, a Previous State, a Next State, a Signer Identifier, and a Signature.
